(19) United States
(12) Patent Application Publication
(10) Pub. No.: US 2026/0023025 A1
(43) Pub. Date: Jan. 22, 2026

(54) MEASURING DEVICE

(71) Applicant: Endress+Hauser Conducta GmbH+Co. KG, Gerlingen (DE)

(72) Inventors: Lukas Graf, Mutlangen (DE); Matthias Grossmann, Vaihingen-Enz (DE); Thilo Krätschmer, Gerlingen (DE); Holger Lippert, Leisnig (DE); Hans Meyer, Eschach (DE); Andreas Müller, Ostfildern (DE); Alejandro Vaca Torres, Steinheim (DE)

(21) Appl. No.: 19/269,672

(22) Filed: Jul. 15, 2025

(30) Foreign Application Priority Data
Jul. 18, 2024 (DE) 10 2024 120 249.1
Mar. 27, 2025 (DE) 10 2025 111 958.9

(51) Int. Cl. G01N 21/85; G01N 21/05; G01N 21/41; G01N 21/64

(52) U.S. Cl. CPC G01N 21/85; G01N 21/05; G01N 21/41; G01N 21/645; G01N 2021/4106; G01N 2201/0636

(57) ABSTRACT

A measuring apparatus with an optical sensor for optically measuring at least one measured variable of a medium includes a closed housing, a flow cell with a measuring chamber arranged in the housing, a reference chamber arranged in the housing and a carrier rotatably mounted in the housing. The optical sensor comprises at least one light source and at least one detector, which are arranged on the carrier in such a way that measurements of the at least one measured variable can be performed on a medium located in the measuring chamber using the optical sensor when the carrier is in a measuring position that can be accessed by rotating the carrier, and reference measurements can be carried out on a reference medium located in the reference chamber using the optical sensor when the carrier is in a reference position that can be accessed by rotating the carrier.

The present application is related to and claims the priority benefit of German Patent Application No. 10 2024 120 249.1, filed on Jul. 18, 2024, and German Patent Application No. 10 2025 111 958.9, filed on Mar. 27, 2025, the entire contents of which are incorporated herein by reference.

### TECHNICAL FIELD

The disclosure relates to a measuring apparatus with an optical sensor for measuring a measured variable of a medium.

### BACKGROUND

Measuring apparatuses with optical sensors, such as turbidity sensors, absorption sensors and/or sensors for measuring the concentration of an analyte contained in the medium, are used in a variety of different applications, e.g., in breweries, sewage treatment plants, laundries and drinking water plants, for measuring different measured variables of the medium.

Optical sensors usually comprise a light source that emits light into the medium during measurement operation, and a detector that receives the measuring radiation resulting from an interaction, such as absorption, reflection, fluorescence and/or scattering, of the transmitted light with the medium and provides a detector signal corresponding to the received measuring radiation. These detector signals are usually made available to an evaluation device, which uses the detector signals to determine and provide measured values of the measured variable.

In order to ensure consistently high measurement accuracy with optical sensors, the measurement accuracy of optical sensors is usually checked at regular intervals. Alternatively or additionally, calibration and/or adjustment of the optical sensor is carried out at regular intervals. Both the verification and the calibration and/or adjustment are usually carried out using reference measurements carried out with the corresponding sensor on a reference medium. In some cases, reference media may be used that are hazardous to health and/or may pose a risk to humans and/or the environment for other reasons. An example of this is the carcinogenic reference medium formazin, which is specified as the standard in many locations for reference measurements to be carried out with turbidity sensors. When using reference media that are hazardous to health and/or dangerous for other reasons, such as formazin, measures are required to protect operating personnel and the environment.

DE 11 2017 005 875 B4 describes a system for the process-integrated optical analysis of flowable media, comprising an optical measuring head, a flow cell through which the medium can flow, and a reference unit for carrying out reference measurements. The system includes kinematics for moving the measuring head to defined relative positions relative to the flow cell and/or the reference unit. Using this kinematics, the measuring head can be moved either into a first relative position in which measurements can be carried out on the medium flowing through the flow cell with the measuring head, or into a second relative position in which measurements can be carried out on the reference unit with the measuring head. In relative positions where the measuring head is neither adjacent to the flow cell nor to the reference unit, measurements can also be carried out in the ambient air.

The system offers the advantage that measurements can be carried out on a reference medium located in the reference unit without affecting and/or contaminating the medium flowing through the flow cell. However, in some locations there is a risk that components of measuring apparatuses exposed to the environment, such as the measuring head, the flow cell and/or the reference cell of the system described in DE 11 2017 005 875 B4, may become fogged up due to moisture condensing on them. Condensation on components such as windows through which optical signals are transmitted during measurements can significantly impair the measurement accuracy achievable with optical sensors. This problem is more serious the more moisture there is in the ambient air and the higher the temperature of the ambient air is compared to the temperature of the corresponding component and/or medium. High air humidity can occur, for example, in poorly ventilated locations. In addition, air movements can also continuously transport moisture towards the components, which may then condense on the components.

There is a variety of applications in which optical sensors are operated in a bypass or in a sampling line through which medium can be diverted from the application. This offers the advantage that maintenance work, checks of the measurement accuracy of the sensors, as well as calibrations and/or adjustments can be carried out without disrupting the processes running in the application. A further advantage is that samples of the medium branched off via sampling lines can be disposed of after the measurements have been carried out to avoid contamination of the medium remaining in the application. It is usually desirable to keep the volume of the medium required for carrying out the measurements as small as possible. In these applications, there is also a risk of condensate forming. This risk is particularly high if the medium in the bypass or sampling line has a significantly lower temperature than the environment of the optical sensor.

### SUMMARY

It is an object of the disclosure to provide a measuring apparatus with an optical sensor with which measurements on the medium and, if required, also reference measurements on a reference medium can be carried out, and which offers improved protection against condensate formation.

For this purpose, the disclosure comprises a measuring apparatus for optically measuring at least one measured variable of a medium, comprising a closed housing, a flow cell with a measuring chamber arranged in the housing for receiving the medium, a reference chamber arranged in the housing for receiving a reference medium, a carrier arranged in the housing with a first carrier region running into a cavity arranged between the measuring chamber and the reference chamber, and a second carrier region running outside the cavity at least in a direction running perpendicular to a longitudinal axis of the first carrier region, wherein the carrier is rotatably mounted in the housing about a longitudinal axis of the first carrier region, and an optical sensor for measuring the measured variable(s), comprising at least one light source and at least one detector arranged on the carrier such that measurements of the measured variable(s) can be carried out on the medium located in the measuring chamber using the optical sensor when the carrier is in a measuring position that can be reached by rotating the carrier, and reference measurements can be carried out on the reference medium located in the reference chamber using the optical sensor when the carrier is in a reference position that can be reached by rotating the carrier

The measuring apparatus offers the advantage that the measuring chamber, the reference chamber and the optical sensor are protected by the closed housing from any moisture that may be present in the surroundings of the housing. In addition, the carrier, which is rotatably mounted in the housing, offers the advantage that the carrier can be easily transferred to the measuring position for carrying out measurements on the medium and to the reference position for carrying out reference measurements on the reference medium, without moisture penetrating into the housing from the outside and without large volumes of air being moved inside the housing. This also provides reliable protection against condensation in combination with the limited internal volume of the housing.

One embodiment consists in that the first carrier region is rod-shaped, and the second carrier region is designed as a rod-shaped region running on one side of the first carrier region in a direction running perpendicular to the longitudinal axis of the first carrier region or comprises a disc which also runs at least in a direction running perpendicular to the first carrier region and/or is rotationally symmetrical to the longitudinal axis of the first carrier region.

A development provides that the carrier comprises a third carrier region,
a) on which a reflector is arranged or on which at least one light source and/or at least one detector of the optical sensor is arranged, and/or
b) which is arranged in the housing on a side of the cavity arranged between the measuring chamber and the reference chamber opposite the second carrier region, outside the cavity, and/or
c) which runs in a direction running perpendicular to the longitudinal axis of the first carrier region, is designed as a rod-shaped region or comprises a disc.

Further embodiments consist in that:
a) each light source and each detector is arranged on a side of one of the carrier regions of the carrier facing the measuring chamber in the measuring position and the reference chamber in the reference position,
b) each light source is designed to emit light of at least one wavelength or at least one wavelength in the ultraviolet, visual and/or infrared spectrum, and/or comprise one or more light-emitting diodes, and/or
c) each detector is positioned on the carrier such that, when the carrier is in the measuring position, it receives measuring radiation resulting from an interaction of the light transmitted by the light source or by at least one of the light sources with the medium and, when the carrier is in the reference position, it receives measuring radiation resulting from an interaction of the light transmitted by the light source with the reference medium, and/or is designed in such a way that it provides a detector signal corresponding to the received measuring radiation, and/or comprises one or more photodiodes.

Further developments consist in that the optical sensor is designed and/or can be used as a turbidity sensor, and/or the detector or at least one of the detectors is arranged on the carrier such that, when the carrier is in the measuring position, it receives measuring radiation resulting from scattering of the light sent into the medium by the light source or one of the light sources at a scattering angle predetermined by the position of the corresponding detector and, when the carrier is in the reference position, it receives measuring radiation resulting from scattering of the light sent into the reference medium by the light source at the scattering angle predetermined by the position of the corresponding detector.

Further developments provide that
a) the optical sensor is designed and/or usable as an absorption sensor,
b) a light source and a detector of the optical sensor are arranged on the carrier in such a way that an optical signal transmission path running from the light source in the transmission direction of the light source to the detector comprises a transmission path running through the measuring chamber when the carrier is in the measuring position and comprises a transmission path running through the reference chamber when the carrier is in the reference position, and/or
c) at least one first reflector and at least one second reflector are arranged in the housing and a light source and a detector of the optical sensor are arranged on the carrier in such a way that an optical signal transmission path running from the light source to the detector when the carrier is in the measuring position runs via at least one first reflector and comprises at least one transmission path running through the measuring chamber, and an optical signal transmission path running from the light source to the detector when the carrier is in the reference position runs via at least one second reflector and comprises at least one transmission path running through the reference chamber.

A further development consists in that the carrier comprises a third carrier region which is arranged in the housing on a side of the cavity arranged between the measuring chamber and the reference chamber, opposite the second carrier region, outside the cavity, a reflector is arranged on one of the two opposing carrier regions formed by the second carrier region and the third carrier region, and a light source and a detector are arranged on the opposite carrier region in such a way that an optical signal transmission path running from the light source via the reflector to the detector comprises a transmission path running through the measuring chamber when the carrier is in the measuring position, and comprises a transmission path running through the reference chamber when the carrier is in the reference position.

Further developments provide that
a) the optical sensor is designed and/or usable as a fluorescence sensor, and/or
b) a light source and at least one detector of the optical sensor are designed and arranged on the carrier in such a way that a fluorescent component contained in the medium can be excited by means of the light source when the carrier is in the measuring position and a fluorescent component contained in the reference medium can be excited when the carrier is in the reference position, and the detector receives fluorescent light transmitted by the fluorescent component of the medium when the carrier is in the measuring position and fluorescent light transmitted by the fluorescent component of the reference medium when the carrier is in the reference position and provides a detector signal corresponding to the received fluorescent light.

Further developments provide that the housing comprises a housing cover detachably connected to a housing body of the housing, and/or the carrier is fastened to a housing cover which is detachably connected to a housing body of the housing in such a way that it can be removed from the housing body together with the housing cover.

According to a further development, the measuring apparatus comprises a detection apparatus for detecting a carrier position of the carrier, which detects when the carrier is in the measuring position and/or which detects when the carrier is in the reference position, and which provides an output signal corresponding to the carrier position, wherein the detection apparatus:
a) comprises two switches or two switches designed as pressure switches, proximity switches or light barriers, which are positioned in the housing in such a way that one of the switches can be triggered by the carrier in the measuring position and the other switch can be triggered by the carrier in the reference position,
b) is connected to a display for displaying a carrier position of the carrier determined by means of the detection apparatus, and/or
c) is connected to an electronic system of the measuring apparatus via which the optical sensor is supplied with energy, comprising a controller for controlling the measuring sequences to be carried out using the optical sensor and/or for controlling the light source(s), and/or which makes the detector signals available to an evaluation device which is designed to determine and make available measurement results of the measured variable(s) of the medium based on the detector signals when the carrier is in the measuring position and/or measurement results (mr) of the measured variable(s) of the reference medium when the carrier is in the reference position. According to a further development, the measuring apparatus is designed such that:
when the carrier is in the measuring position and/or depending on an output signal of a detection apparatus indicating the measuring position for detecting a carrier position of the carrier, it can be operated in a measuring mode in which measurements can be carried out on the medium using the optical sensor, and
when the carrier is in the reference position and/or depending on an output signal of the detection apparatus indicating the reference position, it can be operated in a reference mode in which reference measurements can be carried out on the reference medium using the optical sensor.

Further developments consist in that the measuring apparatus is designed as a measuring module that can be inserted into a measuring module receptacle of a measuring fitting, and/or the measuring apparatus comprises an extension which is adjacent to the housing and through which an inlet connected to the measuring chamber and an outlet connected to the measuring chamber run, and can be inserted into a measuring module receptacle of a measuring fitting in such a way that the inlet can be connected to a supply line which can be connected to the measuring fitting via channels integrated in the measuring fitting and the outlet can be connected to a discharge line which can be connected to the measuring fitting via channels integrated in the measuring fitting.

Further developments provide that the reference chamber is designed as a closed and/or replaceable chamber filled with the reference medium, or the reference chamber is designed as a refillable chamber, wherein at least one channel running through the housing, in each case designed as a filling and/or removal channel, is connected to the reference chamber, the end of which channel arranged outside the housing can be or is closed with a closure.

According to further developments, the measuring apparatus is designed such that:
a) the measuring chamber and the reference chamber, at least in their regions arranged at the level of the first carrier region, are mirror-symmetrical to the first carrier region and/or have identical cross-sectional areas,
b) the measuring chamber and the reference chamber have circular, rectangular, square or octagonal cross-sectional areas, at least in their regions arranged at the level of the first carrier region,
c) the carrier is connected to a rotary knob arranged outside the housing for rotating the carrier and/or to a drive arranged inside or outside the housing or to an electric motor for rotating the carrier,
d) it comprises a first stop against which the carrier strikes when reaching the measuring position, and/or a second stop against which the carrier strikes when reaching the reference position,
e) it comprises a fixing apparatus, a fixing apparatus with magnets and magnets of opposite polarity, a locking apparatus with mutually complementary locking elements or a parking brake, by means of which the carrier can be fixed in the measuring position and/or in the reference position, and/or
f) the optical sensor comprises an electronic system or an electronic system arranged in the carrier, on the carrier or in a rotary knob which is connected to the carrier, or which can be connected or coupled to an electronic system via which the optical sensor is supplied with energy, comprising a controller for controlling measuring sequences to be carried out using the optical sensor and/or for controlling the light source(s), and/or makes the detector signals of each detector available to an evaluation device which is connected or which can be connected to the electronic system, wherein the evaluation device is designed to determine and make available measurement results of the measured variable(s) of the medium based on the detector signals when the carrier is in the measuring position and/or measurement results of the measured variable(s) of the reference medium when the carrier is in the reference position, and/or
g) at least one or each light source and/or at least one or each detector of the optical sensor is arranged in a recess of the carrier which is open to the environment.

Further developments provide that
the measuring chamber and the reference chamber each comprise a pipe segment of a pipe produced in a pipe drawing process, or
a pipe segment of the measuring chamber and a pipe segment of the reference chamber are parts of a single pipe produced in a pipe drawing process, wherein the pipe segments have ends facing one another in the pipe and/or adjoining one another in the pipe, mutually facing ends of the two pipe segments in the housing are both arranged on the same side of the longitudinal axis of the first carrier region in a direction running parallel to the longitudinal axes of the pipe segments, and/or markings pointing in the same radial spatial direction are applied to the pipe segments on the outside of the pipe, and the measuring chamber and the reference chamber are inserted into the housing in an orientation in which the marking on the pipe segment of the measuring chamber and the marking on the pipe segment of the reference chamber point in the same spatial direction running perpendicular to the longitudinal axes of the pipe segments. Further developments consist in that the measuring chamber is equipped with a vent valve and/or in that an inlet which can be connected to a supply line opens into a first end region of the measuring chamber, wherein the first end region forms or comprises a bubble trap, and/or in that the inlet opens into an outer edge region of the first end region.

Further developments provide that a desiccant comprising a moisture-adsorbing material, zeolite or silica gel is arranged in the housing, and/or at least one condensate trap is arranged in the housing and/or a condensate trap arranged in the housing is attached to a portion of the measuring chamber which lies outside a measuring portion of the measuring chamber, in which measurements can be carried out on the medium using the optical sensor through a wall of the measuring portion, is designed as a sleeve or coating surrounding a portion of the measuring chamber on the outside, and/or consists of a metal or a material which has a higher thermal conductivity than a wall of a measuring portion of the measuring chamber through which measurements can be carried out on the medium using the optical sensor.

An embodiment consists in that
the second carrier region arranged outside the cavity arranged between the measuring chamber and the reference chamber and a third carrier region of the carrier opposite the second carrier region on the other side of the cavity each comprise a disc-shaped and/or rotationally symmetrical region to the longitudinal axis of the first carrier region, and
a region of the first carrier region arranged in the cavity is rotationally symmetrical to the longitudinal axis of the first carrier region and has a cross-sectional area in a sectional plane spanned by the longitudinal axis of the first carrier region and a transverse axis running perpendicular to the longitudinal axis of the first carrier region and perpendicular to the longitudinal axes of the measuring chamber and the reference chamber, which cross-sectional area corresponds to a cross-sectional area of the cavity, which the cavity has in this sectional plane.

A further embodiment consists in that
the region of the first carrier region arranged in the cavity has an outer diameter at each position along its longitudinal axis, which is dimensioned such that between an outer circumferential surface of the measuring chamber facing the longitudinal axis of the first carrier region and the region, as well as between an outer circumferential surface of the reference chamber facing the longitudinal axis of the first carrier region and the region, in a sectional plane spanned by the longitudinal axis of the first carrier region and a transverse axis running perpendicular to the longitudinal axis of the first carrier region and perpendicular to the longitudinal axes of the measuring chamber and the reference chamber there is a gap, which has a gap width enabling the rotation of the carrier and/or a gap width of 0.05 mm to 1 mm, and/or
the outer dimensions of the disc-shaped region of the second carrier region and of the disc-shaped region of the third carrier region are each dimensioned such that each of these regions has a cross-sectional area which corresponds to a cross-sectional area which one of the two partial regions of the housing interior adjacent to the cavity in the housing comprises in the sectional plane spanned by the longitudinal axis of the first carrier region and the transverse axis running perpendicular to the longitudinal axis of the first carrier region and perpendicular to the longitudinal axes of the measuring chamber and the reference chamber.

Further developments consist in that:
at least one filler body is arranged in the housing, and/or
the measuring chamber is surrounded externally on all sides by a filler body which has a through-opening for each light source through which the corresponding light source emits light into the measuring chamber when the carrier is in the measuring position, and has in each case a through-opening for each detector through which the corresponding detector receives measuring radiation emerging from the measuring chamber when the carrier is in the measuring position, and/or
the reference chamber is surrounded externally on all sides by a filler body which has a through-opening for each light source through which the corresponding light source transmits light into the reference chamber when the carrier is in the reference position, and has a through-opening for each detector through which the corresponding detector receives measuring radiation emerging from the measuring chamber when the carrier is in the reference position.
   Further developments provide that the carrier is equipped with at least one element which at least partially limits and/or reduces the free volume in the housing directly or indirectly adjacent to the measuring chamber and/or the reference chamber, wherein:
a) each element is annular, is designed as a seal, as an O-ring or as a shaped seal, is inserted into a groove provided for this purpose in the carrier, is designed as an element projecting in a radial direction parallel to the longitudinal axis or in an axial direction perpendicular to the longitudinal axis, and/or is arranged concentrically to the longitudinal axis of the first carrier region,
b) the elements comprise at least one element extending outside the first carrier region, at least one element arranged on each end face of the second carrier region or the third carrier region facing the measuring chamber and the reference chamber, at least two elements arranged opposite one another on the mutually facing end faces of the second carrier region and the third carrier region, and/or at least one element extending outside the disc-shaped region of the second carrier region and/or at least one element extending outside the disc-shaped region of the third carrier region,
c) at least two elements each have a portion facing the measuring chamber and a portion facing the reference chamber, and/or
d) at least one or each light source and/or at least one or each detector of the optical sensor is arranged in each case at a position in or on the carrier located between two mutually adjacent elements.

Further embodiments consist in that the optical sensor is designed and/or usable as a turbidity sensor or as a fluorescence sensor, and/or the optical sensor:
comprises a light source which is designed to transmit light into the measuring chamber in a transmission direction running at an angle of 45° to the longitudinal axis of the first carrier region when the carrier is in the measuring position and to transmit light into the reference chamber at an angle of 45° to the longitudinal axis when the carrier is in the reference position, and
comprises a detector which is designed to receive measuring radiation emerging from the measuring chamber at an angle of 90° to the transmission direction resulting from an interaction of the light with the medium when the carrier is in the measuring position, and to receive measuring radiation emerging from the reference chamber at an angle of 90° to the transmission direction resulting from an interaction of the light with the reference medium when the carrier is in the reference position.

Further developments provide that the carrier can be transferred into an intermediate position by rotating the carrier about the longitudinal axis of the first carrier region, wherein:
each detector and each light source of the optical sensor, when the carrier is in the intermediate position, is aligned with a partial region of an interior space of the housing located between the measuring chamber and the reference chamber,
the housing has a removable housing cover which closes a housing opening through which each detector and each light source of the optical sensor is accessible when the carrier is in the intermediate position, and/or
a reference body made of Plexiglas, glass or a reference material is arranged in the housing in such a way that reference measurements can be carried out on the reference body using the optical sensor when the carrier is in the intermediate position.

According to a further development, the measuring apparatus comprises a connection apparatus which is operable in a first mode in which the measuring chamber can be filled with the medium via the connection apparatus, and which is operable in a second mode in which the measuring chamber can be filled with a reference fluid different from the medium via the connection apparatus, wherein:
the connection apparatus is connected to the measuring chamber, and/or
the connection apparatus comprises a fitting or a fitting comprising a multi-way valve, wherein the fitting comprises a measuring chamber connection connected to the measuring chamber, a medium connection which can be connected to a supply line carrying the medium, via which the measuring chamber can be filled with the medium, and a connection device via which the measuring chamber can be connected to a supply line carrying the reference fluid for filling the measuring chamber with the reference fluid and via which the measuring chamber can be connected to a withdrawal line for discharging reference fluid located in the measuring chamber, and/or
the connection apparatus comprises a shut-off apparatus inserted into an outlet for the medium connected to the measuring chamber, via which shut-off apparatus the measuring chamber can be ventilated when the measuring chamber is filled with the reference fluid and/or when the reference fluid is drained from the measuring chamber, and/or via which the outlet can be shut off at least temporarily in such a way that the shut-off apparatus prevents reference fluid from escaping from the measuring chamber via the outlet.

Furthermore, the disclosure comprises a method for operating a measuring apparatus according to the disclosure, in which measurements of the measured variable(s) of the medium are carried out using the optical sensor when the carrier is in the measuring position, at least one reference measurement is carried out on the reference medium in the reference chamber using the optical sensor at least once, repeatedly or as required when the carrier is in the reference position, and a check of the measurement accuracy, a calibration and/or an adjustment of the optical sensor is carried out based on the reference measurement(s).

Developments of the method consist in that:
a) the carrier is transferred at least once, repeatedly or as required into an intermediate position in which reference measurements can be carried out using the optical sensor on a reference body arranged in the housing, and based on at least one reference measurement carried out on the reference body, a check of the measurement accuracy, a calibration and/or an adjustment of the optical sensor is carried out, and/or a check of at least one reference measurement carried out on the reference medium located in the reference chamber and/or at least one property of the reference medium is carried out, and/or
b) the measuring chamber is filled with a reference fluid at least once, repeatedly or as required, at least one reference measurement is carried out on the reference fluid in the measuring chamber using the optical sensor, and based on the reference measurement(s) carried out on the reference fluid, a check of the measurement accuracy, a calibration and/or an adjustment of the optical sensor is carried out, and/or a check of at least one reference measurement carried out on the reference medium in the reference chamber and/or at least one property of the reference medium is carried out.

### BRIEF DESCRIPTION OF THE DRAWINGS

The present disclosure and its advantages will now be explained in detail using the figures in the drawing, which show several examples of embodiments. The same elements are indicated by the same reference numbers in the figures.

FIG. 1 shows a measuring apparatus with a rod-shaped second carrier region;

FIG. 2 shows an exemplary embodiment of the optical sensor of the measuring apparatus of FIG. 1 with the carrier arranged in the measuring position;

FIG. 3 shows the exemplary embodiment of FIG. 2 with the carrier arranged in the reference position;

FIG. 4 shows a measuring apparatus with a disc-shaped second carrier region;

FIG. 5 shows an exemplary embodiment of the optical sensor of the measuring apparatus of FIG. 4 with the carrier arranged in the measuring position;

FIG. 6 shows the exemplary embodiment of FIG. 5 with the carrier arranged in the reference position;

FIG. 7 shows a further exemplary embodiment of the optical sensor of the measuring apparatus of FIG. 4 with the carrier arranged in the measuring position;

FIG. 8 shows the exemplary embodiment of FIG. 7 with the carrier arranged in the reference position;

FIG. 9 shows a measuring apparatus with a third carrier region with the carrier arranged in the measuring position;

FIG. 10 shows the measuring apparatus of FIG. 9 with the carrier arranged in the reference position;

FIG. 11 shows a modification of the measuring apparatus of FIGS. 9 and 10 with an absorption sensor with the carrier arranged in the measuring position;

FIG. 12 shows the measuring apparatus of FIG. 11 with the carrier arranged in the reference position;

FIG. 13 shows an exemplary embodiment of the measuring apparatus of FIG. 1, which comprises stops and a detection apparatus;

FIG. 14 shows an exemplary embodiment of the measuring apparatus of FIG. 4, which comprises stops and locking apparatuses;

FIG. 15 shows a method for producing a measuring chamber and a reference chamber;

FIG. 16 shows a measuring apparatus inserted into a measuring apparatus; and

FIG. 17 shows a measuring apparatus having a bubble trap, a condensate trap, and a desiccant;

FIG. 18 shows a measuring apparatus with a refillable reference chamber.

FIG. 19 shows another exemplary embodiment of a measuring apparatus with the carrier arranged in the measuring position;

FIG. 20 shows the measuring apparatus of FIG. 19 with the carrier arranged in the reference position;

FIG. 21 shows a measuring apparatus with at least one filler body with the carrier arranged in the measuring position;

FIG. 22 shows the measuring apparatus of FIG. 21 with the carrier arranged in the reference position;

FIG. 23 shows a measuring apparatus with a carrier that can be transferred into an intermediate position; and

FIG. 24 shows a switching apparatus connected to a measuring chamber.

### DETAILED DESCRIPTION

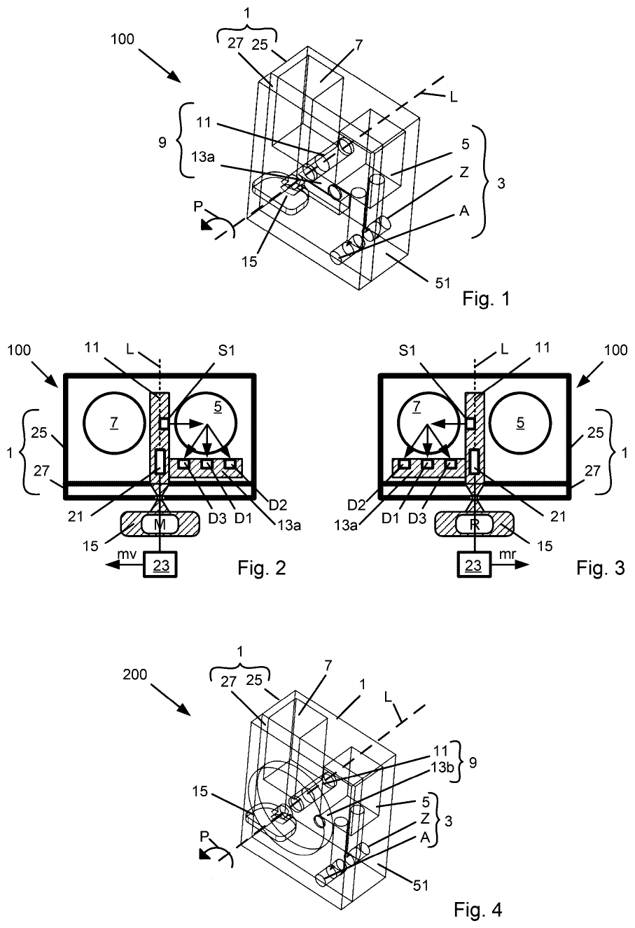

The disclosure discloses a measuring apparatus 100 for optically measuring at least one measured variable of a medium. An exemplary embodiment of this is shown in FIG. 1. The measuring apparatus 100 comprises a closed housing 1, a flow cell 3 with a measuring chamber 5 arranged in the housing 1 for receiving the medium and a reference chamber 7 arranged in the housing 1 for receiving a reference medium. A carrier 9 is arranged in the housing 1 of the measuring apparatus 100. This carrier 9 comprises a first carrier region 11, which extends in the housing 1 into a cavity arranged between the measuring chamber 5 and the reference chamber 7, and a second carrier region 13a, which extends in the housing 1 outside the cavity at least also in a direction running perpendicular to a longitudinal axis L of the first carrier region 11. In addition, the carrier 9 is rotatably mounted in the housing 1 about the longitudinal axis L of the first carrier region 11.

Furthermore, the measuring apparatus 100 comprises an optical sensor for the metrological detection of the measured variable(s), which comprises at least one light source Si arranged on the carrier 9 and at least one detector Dj arranged on the carrier 9. The light source(s) Si and the or each detector Dj are arranged on the carrier 9 in such a way that measurements of the measured variable(s) can be carried out on the medium located in the measuring chamber 5 using the optical sensor when the carrier 9 is in a measuring position that can be reached by rotating the carrier 9, and reference measurements can be carried out on the reference medium located in the reference chamber 7 using the optical sensor when the carrier 9 is in a reference position that can be reached by rotating the carrier 9.

FIG. 1 shows the carrier 9 in the measuring position. FIGS. 2 and 3 show an exemplary embodiment of the measuring apparatus 100 of FIG. 1 in a cross-sectional plane running through the first carrier region 11, which is shown in FIG. 2 with the carrier 9 in the measuring position and in FIG. 3 with the carrier 9 in the reference position. As shown in FIG. 1 by an arrow P, the carrier 9 in the illustrated exemplary embodiment can be transferred from the measuring position to the reference position by rotating the carrier 9 by 180° about the longitudinal axis L of the first carrier region 9. Analogously, the carrier 9 can be moved from the reference position into the measuring position by a rotation, for example, a rotation in the opposite direction.

The rotation of the carrier 9 from the measuring position to the reference position, as well as from the reference position to the measuring position, can be effected in different ways. FIG. 1 shows an exemplary embodiment in which the carrier 9 is connected to a rotary knob 15 arranged outside the housing 1, which enables manual rotation of the carrier 9. Alternatively or additionally, the carrier 9 can also be connected to a drive arranged inside or outside the housing 1 for rotating the carrier 9, such as an electric motor.

The carrier 9 can be designed in different ways. FIGS. 1, 2, and 3 show an exemplary embodiment in which the first carrier region 11 and the second carrier region 13a are rod-shaped, and the second carrier region 13a extends only on one side of the first carrier region 11 in a direction running perpendicular to the longitudinal axis L of the first carrier region 11. This embodiment offers the advantage that the height of the housing 1 can be limited to a minimum height required for rotating the carrier 9 from the measuring position to the reference position and back, which is only slightly greater than the length of the second carrier region 13a. The correspondingly small size of the interior space remaining free in the housing 1 offers the advantage that a correspondingly small volume of air is enclosed in the housing 1, which may contain residual air humidity.

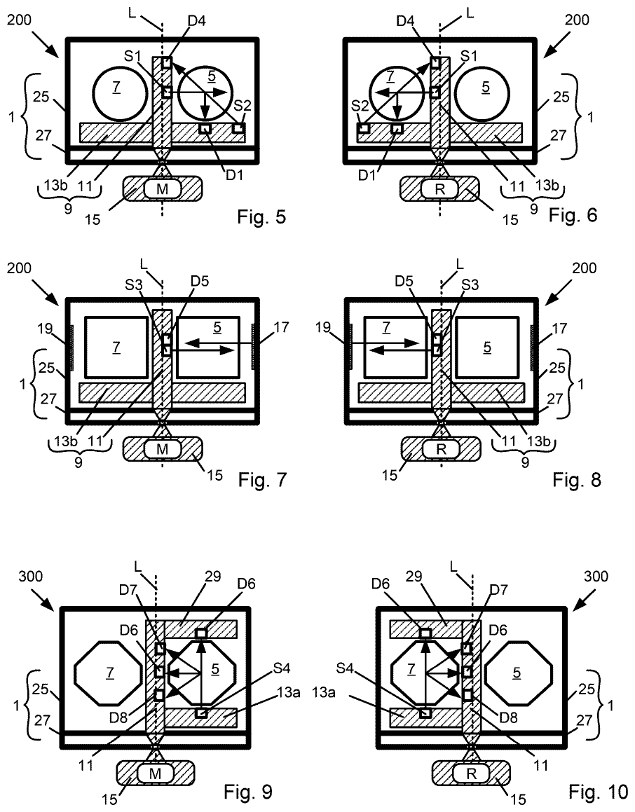

FIG. 4 shows, as a further exemplary embodiment, a measuring apparatus 200 constructed analogously to the measuring apparatus 100 shown in FIG. 1, in which the first carrier region 11 is rod-shaped and the second carrier region 13b comprises a disc which extends at least in a direction running perpendicular to the first carrier region 11 and/or is rotationally symmetrical to the longitudinal axis L of the first carrier region 11. FIG. 5 shows an exemplary embodiment of the measuring apparatus 200 of FIG. 4 with the carrier 9 in the measuring position in a cross-sectional plane passing through the first carrier region 11. FIG. 6 shows the exemplary embodiment shown in FIG. 5 with the carrier 9 in the reference position in the cross-sectional plane passing through the first carrier region 11. As shown in FIG. 4 by an arrow P, the carrier 9 can also be transferred from the measuring position shown in FIGS. 4 and 5 to the reference position shown in FIG. 6 by rotating the carrier 9 by 180° about the longitudinal axis L of the first carrier region 11. Analogously, the carrier 9 can be moved from the reference position into the measuring position by a rotation, for example, a rotation in the opposite direction. The disc-shaped second carrier region 13b offers the advantage over the rod-shaped second carrier region 13a shown in FIGS. 1 to 3 that the disc can be rotated in the housing 1 without causing any significant displacement of air trapped in the housing 1. This reduces the air exchange of the air volume adjacent to the measuring chamber 5 and the reference chamber 7 caused by the rotation of the carrier 9. This offers the advantage of even better protection against condensation.

In the exemplary embodiments shown in FIGS. 1 to 6, the second carrier region 13a, 13b is each aligned perpendicular to the longitudinal axis L of the first carrier region 11. Alternatively, the second carrier region arranged outside the cavity and extending at least perpendicularly to the longitudinal axis of the first carrier region 11 can also have an orientation deviating from the vertical orientation.

Irrespective of the relevant embodiment of the carrier 9, the measurements on the medium and the reference measurements on the reference medium are made possible, for example, by each light source S1 and each detector Dj being arranged on a side of one of the carrier regions 11, 13a, 13b of the carrier 9 facing the measuring chamber 5 in the measuring position and the reference chamber 7 in the reference position. Each light source Si is designed, for example, to emit light of at least one wavelength, such as at least one wavelength in the ultraviolet, visual and/or infrared spectrum. One exemplary embodiment of this is light sources Si which comprise one or more light-emitting diodes. In addition, each detector Dj is positioned on the carrier 9 in such a way that, when the carrier 9 is in the measuring position, it receives measuring radiation resulting from an interaction, such as fluorescence, reflection, absorption and/or scattering, of the light transmitted by the light source Si or one of the light sources Si with the medium and, when the carrier 9 is in the reference position, it receives measuring radiation resulting from the interaction of the light transmitted by the light source Si with the reference medium. In this case, each detector Dj is designed in such a way that it determines and provides a detector signal corresponding to the received measuring radiation, such as a detector signal corresponding to a radiation intensity of the received measuring radiation. One exemplary embodiment of this is detectors Dj which comprise one or more photodiodes.

Depending on the number, positioning and/or orientation of the light sources Si and/or the detectors Dj, the optical sensor can be used to measure different measured variables of the medium, such as turbidity of the medium, absorption of the medium, a measured variable that can be determined based on the measured absorption, such as a concentration of an analyte contained in the medium, fluorescence of the medium, and/or a measured variable that can be determined based on the measured fluorescence, such as a concentration of a fluorescent component contained in the medium.

One embodiment of this is that the optical sensor is designed and/or can be used as a turbidity sensor. In this case, the detector Dj or at least one of the detectors Dj of the optical sensor is arranged on the carrier 9 in such a way that, when the carrier 9 is in the measuring position, it receives measuring radiation resulting from a scattering of the light sent into the medium by the light source Si or one of the light sources Si at a scattering angle predetermined by the position of the corresponding detector Dj and, when the carrier 9 is in the reference position, it receives measuring radiation resulting from a scattering of the light sent into the reference medium by the light source Si at the scattering angle predetermined by the position of the corresponding detector Dj.

FIGS. 2 and 3 show an exemplary embodiment of the optical sensor of the measuring apparatus 100 shown in FIG. 1, in which the light source S1 is arranged on the first carrier region 11 in such a way that, when the carrier 9 is in the measuring position, it transmits light into the measuring chamber 5 in a transmission direction running perpendicular to the longitudinal axis L of the first carrier region 11, and it transmits light into the reference chamber 7 in a direction running perpendicular to the longitudinal axis L of the first carrier region 11 when the carrier 9 is in the reference position. The detectors D1, D2, D3 shown as examples in FIGS. 2 and 3 and usable for turbidity measurement comprise three detectors D1, D2, D3 arranged distributed along the second carrier region 13a. The first detector D1 is arranged in a central region of the second carrier region 13a such that it receives measuring radiation scattered at a scattering angle of 90° to the transmission direction of the light source S1. The second detector D2 is arranged in a region of the second carrier region 13a facing away from the first carrier region 11 such that it receives measuring radiation scattered from forward scattering at a scattering angle of less than 90° to the transmission direction of the light source S1, such as forward scattering at a scattering angle of 45°. The third detector D3 is arranged in a region of the second carrier region 13a facing the first carrier region 11 such that it receives measuring radiation scattered from a backward scattering at a scattering angle of more than 90° to the transmission direction of the light source S1, such as a backward scattering at a scattering angle of 135°.

Alternatively or additionally, the optical sensor is designed and/or can be used as a fluorescence sensor, for example. In this case, the sensor comprises a light source Si, by which a fluorescent component contained in the medium is excited when the carrier 9 is in the measuring position and a fluorescent component contained in the reference medium is excited when the carrier 9 is in the reference position, and a detector Dj, which receives fluorescent light transmitted by the fluorescent component of the medium when the carrier 9 is in the measuring position and fluorescent light transmitted by the fluorescent component of the reference medium when the carrier 9 is in the reference position. For this purpose, the measuring arrangement shown in FIGS. 2 and 3 can be used. In this case, the light source S1 is designed as a fluorescence-exciting light source and at least one of the detectors D1, D2, D3 is designed to provide a detector signal corresponding to the fluorescent light transmitted in the direction of the corresponding detector D1, D2, D3 and received by the corresponding detector D1, D2, D3.

Alternatively or additionally, the optical sensor is designed and/or can be used as an absorption sensor. FIGS. 5 and 6 show an exemplary embodiment of the optical sensor of the measuring apparatus 200 shown in FIG. 4, in which a light source S2 and a detector D4 of the optical sensor are arranged on the carrier 9 in such a way that an optical signal transmission path running from the light source S2 in the transmission direction of the light source S2 to the detector D4 comprises a transmission path running through the measuring chamber 5 when the carrier 9 is in the measuring position and comprises a transmission path running through the reference chamber 7 when the carrier 9 is in the reference position. In the example shown, the light source S2 is arranged in a region of the second carrier region 13b facing away from the first carrier region 11 and the detector D4 is arranged on a region of the first carrier region 11 facing away from the second carrier region 13b. This offers the advantage of a long transmission path running through the medium in the measuring position and through the reference medium in the reference position.

Alternatively or additionally, absorption measurements in the measuring position and in the reference position can also be carried out by means of an optical signal transmission path running via at least one reflector 17, 19. FIGS. 7 and 8 show an exemplary embodiment of the measuring apparatus 200 shown in FIG. 4 in the cross-sectional plane running through the first carrier region 11, which is shown in FIG. 7 with the carrier 9 in the measuring position and in FIG. 8 with the carrier 9 in the reference position. In this exemplary embodiment, the measuring apparatus 200 comprises at least one first reflector 17 arranged in the housing 1 and at least one second reflector 19 arranged in the housing 1. In addition, a light source S3 and a detector D5 of the optical sensor are positioned as a transmitter-receiver pair on the carrier 9 such that an optical signal transmission path running from the light source S3 to the detector D5 when the carrier 9 is in the measuring position runs via at least one first reflector 17 and comprises at least one transmission path running through the measuring chamber 5 and, when the carrier 9 is in the reference position runs via at least one second reflector 19 and comprises at least one transmission path running through the reference chamber 7. In the illustrated exemplary embodiment, the first reflector 17 is arranged on a side of the measuring chamber 5 opposite the first carrier region 11 and the second reflector 19 is arranged on a side of the reference chamber 7 opposite the first carrier region 11. Accordingly, the light source S3 and the detector D5 are arranged side by side on the side of the first carrier region 11 facing the first reflector 17 in the measuring position and the second reflector 19 in the reference position.

Analogously, the transmitter-receiver pair comprising the light source and the detector can of course also be arranged on the second carrier region 13b. In this case, the first reflector is arranged on a side of the measuring chamber 5 opposite the second carrier region 13b when the carrier 9 is in the measuring position, and the second reflector is arranged on a side of the reference chamber 7 opposite the second carrier region 13b when the carrier 9 is in the reference position. Alternatively, however, a different positioning of the light source S1 and the detector Dj of a transmitter-receiver pair and the reflectors can be selected, in which an optical signal transmission path running from the light source Si to the detector Dj runs over at least one reflector when the carrier 9 is in the measuring position and comprises at least one transmission path running through the measuring chamber 5, and runs over at least one reflector and comprises at least one transmission path running through the reference chamber 7 when the carrier 9 is in the reference position.

Optionally, the optical sensor is designed in such a way that two or more measured variables can be measured simultaneously or successively using the optical sensor. FIGS. 5 and 6 show an exemplary embodiment in which the optical sensor is designed in such a way that it can be used both for absorption measurement and for turbidity measurement. For this purpose, the optical sensor shown here merely as a possible example comprises, in addition to the light source S2 and the detector D4, which can be used for absorption measurement in the manner described above, the light source S1 described above in connection with the turbidity measurement with reference to FIGS. 2 and 3 and at least one of the detectors D1, D2, D3 which can be operated as a turbidity detector in the manner described above with reference to FIGS. 2 and 3.

The measuring apparatus 100, 200 is operated, for example, in such a way that measurements of the measured variable(s) of the medium are carried out using the optical sensor when the carrier 9 is in the measuring position. In addition, at least one reference measurement is carried out on the reference medium located in the reference chamber 7 using the optical sensor, for example at least once, repeatedly or as needed with the carrier 9 in the reference position, based on which a check of the measurement accuracy, a calibration and/or an adjustment of the optical sensor is then carried out. During the test, it is checked, for example, whether certain measured values of the measured variable of the reference medium using the optical sensor correspond within a specified error tolerance with the specified reference values. During calibration, for example, the procedure is such that at least one adjustment value is determined based on at least one measured value of the measured variable of the reference medium determined using the optical sensor and a reference value of the measured variable determined in another way, based on which at least one calibration value used to determine the measured values is checked. During adjustment, calibration values checked during calibration are adjusted, if necessary, using the corresponding adjustment values.

With regard to the execution of the measurements and the reference measurements, the measuring apparatus 100, 200 is designed, for example, such that the optical sensor comprises an electronic system 21 or can be connected or is connected to an electronic system 21 via which the optical sensor is supplied with energy, which comprises a controller for controlling the measuring sequences to be carried out using the optical sensor and/or for controlling the light source(s) Si, and/or which makes the detector signals available to an evaluation device 23. The evaluation device 23, which is designed as a component of the measuring apparatus 100, 200 or which can be connected or is connected to the measuring apparatus 100, 200, is designed, for example, to determine and provide measurement results mv of the measured variable(s) of the medium based on the detector signals when the carrier 9 is in the measuring position and/or measurement results mr of the measured variable(s) of the reference medium when the carrier 9 is in the reference position. FIGS. 2 and 3 show an exemplary embodiment in which the electronic system 21 is arranged in the housing 1 on the carrier 9 and is connected or which can be connected to the evaluation device 23 via a connecting line leading out of the housing 1.

Alternatively or additionally, the measuring apparatus 100, 200 is designed, for example, such that, when the carrier 9 is in the measuring position, it can be operated in a measuring mode in which measurements can be carried out on the medium using the optical sensor and, when the carrier 9 is in the reference position, it can be operated in a reference mode in which reference measurements can be carried out on the reference medium using the optical sensor. The measurements and the reference measurements are each carried out according to a sequence specified by the controller. Alternatively or additionally, the evaluation of the detector signals by means of the evaluation device 23 in the measuring mode and in the reference mode is carried out in a manner predetermined for the corresponding operating mode.

The measuring devices 100, 200 described above and the method for their operation have the advantages mentioned above. Individual components of the measuring apparatus 100, 200 and/or method steps of the method may each have optional embodiments that can be used individually and/or in combination with one another.

An optional embodiment consists in that the housing 1 comprises a housing cover 27 detachably connected to a housing body 25 of the housing 1. This offers the advantage that the housing 1 can be opened if necessary, e.g., for maintenance purposes, to carry out repairs and/or for cleaning purposes. FIGS. 1 to 8 show an exemplary embodiment in which the carrier 9 is attached to the removable housing cover 27. In this embodiment, the carrier 9 can be removed from the housing body 25 together with the housing cover 27. This offers the advantage that each light source S1 and each detector Dj, as well as, if applicable, the electronic system 21 arranged in the housing 1, are freely accessible and can thus be maintained, repaired and/or replaced if necessary. At the same time, both the outer surfaces of the transparent windows or the transparent outer walls of the measuring chamber 5, through which the measurements are taken, and the outer surfaces of the transparent windows or the transparent outer walls of the reference chamber 7, through which the reference measurements are taken, are freely accessible when the carrier 9 is dismounted and can thus be cleaned if necessary.

A further optional embodiment consists in that the carrier 9 comprises at least one further carrier region in addition to the first carrier region 11 and the second carrier region 13a, 13b. This offers the advantage of a correspondingly greater flexibility with regard to the positioning of the light sources Si and the detectors Dj, which can be used, for example, by arranging at least one light source Si and/or at least one detector Dj of the optical sensor on the further carrier region. FIGS. 9 and 10 show an exemplary embodiment of a measuring apparatus 300 constructed analogously to the previously described measuring apparatuses 100, 200 in the cross-sectional plane running through the first carrier region 11, which is shown in FIG. 9 with the carrier 9 in the measuring position and in FIG. 10 with the carrier 9 in the reference position. In this exemplary embodiment, the carrier 9 comprises a third carrier region 29 which extends in a direction running perpendicular to the longitudinal axis L of the first carrier region 11. The third carrier region 29 is arranged in the housing 1 on a side of the cavity arranged between the measuring chamber 5 and the reference chamber 7, opposite the second carrier region 13a, outside the cavity. Accordingly, the carrier 9 can also be transferred from the measuring position to the reference position and vice versa by rotating it about the longitudinal axis L of the first carrier region 11.

Analogous to the second carrier region 13a, the third carrier region 29 is also designed, for example, as a rod-shaped region or as a disc-shaped region. In FIGS. 9 and 10, the second carrier region 13a and the third carrier region 29 are formed as rod-shaped regions arranged opposite one another. This offers the advantage that the carrier 9 can be rotated into a middle position in which the third carrier region 29 can be inserted into the housing 1 through the cavity between the measuring chamber 5 and the reference chamber 7 and can be removed from the housing 1. Accordingly, in this embodiment, the carrier 9 can also be mounted and/or dismounted together with the previously described housing cover 27.

The flexibility gained by the third carrier region 29 with regard to the positioning of the light sources Si and/or the detectors Dj can be used in a variety of ways. FIGS. 9 and 10 show, by way of example, an exemplary embodiment in which a light source S4 is arranged on one of the two opposing carrier regions formed by the second carrier region 13a and the third carrier region 29. This light source S4, together with the detector D6 arranged in FIGS. 9 and 10 on the carrier region opposite the light source S4, forms a transmitter-receiver pair that can be used for absorption measurement. In addition, the light source S4 can be used in combination with at least one of the detectors D6, D7, D8 arranged on the first carrier region 11 in FIGS. 9 and 10 for turbidity measurement. Analogous to the optical sensor described with reference to FIGS. 2 and 3, the optical sensor shown in FIGS. 9 and 10 also comprises, for example, a first detector D6 which is arranged in a central region of the first carrier region 11 in such a way that it receives measuring radiation scattered at a scattering angle of 90° to the transmission direction of the light source S4. Alternatively or additionally, the measuring apparatus 300 comprises, for example, a second detector D7, which is arranged in a first end region of the first carrier region 11 such that it receives measuring radiation scattered from forward scattering at a scattering angle of less than 90° to the transmission direction of the light source S4, such as, for example, forward scattering at a scattering angle of 45°, and/or a third detector D8, which is arranged in a second end region of the first carrier region 11 opposite the first end region such that it receives measuring radiation scattered from backward scattering at a scattering angle of more than 90° to the transmission direction of the light source S4, such as, for example, backward scattering at a scattering angle of 135°.

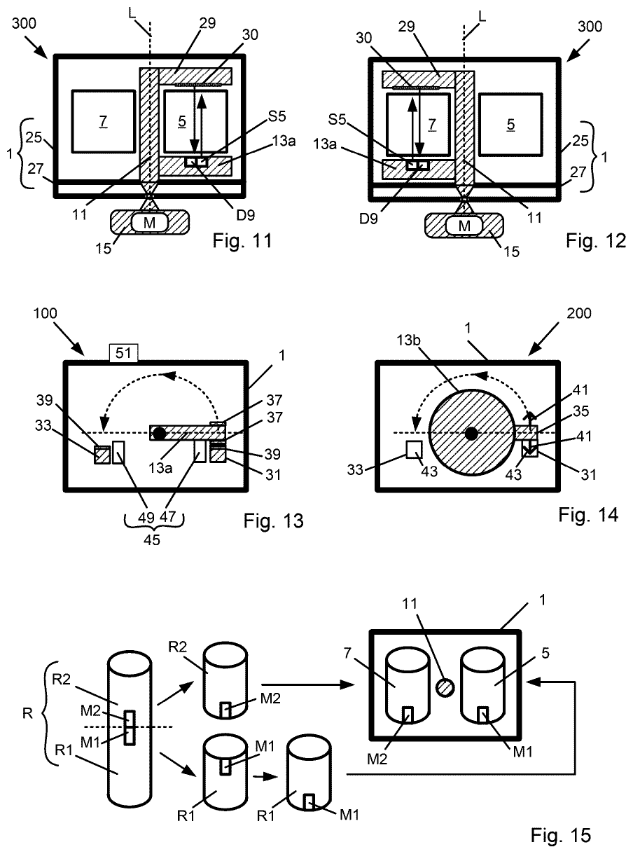

FIGS. 11 and 12 show a further exemplary embodiment in which the optical sensor is designed and/or can be used as an absorption sensor. For this purpose, a transmitter-receiver pair is arranged on one of the two opposing carrier regions formed by the second carrier region 13a and the third carrier region 29, and a reflector 30 is arranged on the opposite carrier region. Analogous to the exemplary embodiment shown in FIGS. 7 and 8, the transmitter-receiver pair here also comprises a light source S5 and a detector D9, which are positioned on the carrier 9 in such a way that an optical signal transmission path running from the light source S5 via the reflector 30 to the detector D9 comprises a transmission path running through the measuring chamber 5 when the carrier 9 is in the measuring position, and a transmission path running through the reference chamber 7 when the carrier 9 is in the reference position.

A further optional embodiment consists in that the measuring apparatus 100, 200, 300 comprises a first stop 31 against which the carrier 9 strikes when reaching the measuring position, and/or a second stop 33 against which the carrier 9 strikes when reaching the reference position. As an example, FIG. 13 shows an exemplary embodiment of the measuring apparatus 100 shown in FIG. 1 in longitudinal section in a sectional plane running through the second carrier region 13a, in which the first stop 31 is arranged in the housing 1 on one side of the longitudinal axis L of the first carrier region 11 such that an end of the second carrier region 13a facing away from the first carrier region 11 rests thereon when the measuring position shown in FIG. 13 is reached. Analogously, the second stop 33 in FIG. 13 is arranged in the housing 1 such that the end of the second carrier region 13a facing away from the first carrier region 11 rests thereon when the reference position is reached.

FIG. 14 shows, as a further exemplary embodiment, a modification of the measuring apparatus 200 shown in FIG. 4 in longitudinal section in a sectional plane running through the second carrier region 13b, in which the second carrier region 13b comprises an outwardly projecting extension 35 which rests on the first stop 31 when the measuring position shown in FIG. 14 is reached and on the second stop 33 when the reference position is reached.

An alternative or additional usable embodiment is that the measuring apparatus 100, 200, 300 comprises a fixing apparatus by means of which the carrier 9 can be fixed in the measuring position and/or in the reference position. A parking brake is suitable for this purpose, for example one acting on the rotary knob 15 or one integrated in the drive, e.g., in the electric motor, which, when activated, prevents further rotation of the carrier 9. FIG. 13 shows, as a further exemplary embodiment, a fixing apparatus comprising magnets 37 and magnets 39 of opposite poles, by means of which the carrier 9 can be fixed in the measuring position and in the reference position. For this purpose, the magnets 37 are arranged, for example, on the opposite sides of the end of the second carrier region 13a facing away from the first carrier region 11. In this case, one of the magnets 39 of opposite poles is arranged on the first stop 31 and the second stop 33. FIG. 14 shows, as a further exemplary embodiment, a fixing apparatus which comprises a locking apparatus with mutually complementary locking elements 41, 43, by means of which the carrier 9 can be fixed in the measuring position and in the reference position. In FIG. 14, the locking apparatus comprises locking elements 41 arranged on the opposite sides of the extension 35 and, in FIG. 14, locking elements 43 complementary to the locking elements 41 integrated in the stops 31, 33.

A further embodiment, also shown as an option in FIG. 13, is that the measuring apparatus 100, 200, 300 comprises a detection apparatus 45 for detecting the carrier position, which detects when the carrier 9 is in the measuring position and/or detects when the carrier 9 is in the reference position, and makes this information available via a corresponding output signal. FIG. 13 shows an exemplary embodiment in which the detection apparatus 45 comprises two switches 47, 49 such as pressure switches, proximity switches or light barriers, which are positioned in the housing 1 in such a way that one of the switches 47 can be triggered by the carrier 9 in the measuring position and the other switch 49 can be triggered by the carrier 9 in the reference position.

Optionally, the detection apparatus 45 is connected, for example, to a display 51 for displaying a carrier position of the carrier 9 determined by means of the detection apparatus 45. A suitable display 51 is, for example, a display attached to the housing 1 or to the evaluation device 23, such as a display or a display comprising at least one display element, such as a single- or multi-colored light-emitting diode.

Alternatively or additionally, the detection apparatus 45 is connected, for example, to the electronic system 21 and/or to the evaluation device 23. The detection apparatus 45 offers the advantage that the operating mode of the measuring apparatus 100, 200, 300 can be selected and/or specified depending on the output signal of the detection apparatus 45. In this case, the measuring apparatus 100, 200, 300 is designed, for example, such that it can be operated in the measuring mode when the output signal of the detection apparatus 45 indicates the measuring position and in the reference mode when the output signal of the detection apparatus 45 indicates the reference position.

Independently of the previously described embodiments, the measuring chamber 5 and/or the reference chamber 7 can also be designed in different ways. An embodiment shown in FIGS. 1 to 12 consists in that the measuring chamber 5 and the reference chamber 7 are formed mirror-symmetrically to the first carrier region 11, at least in their regions arranged at the level of the first carrier region 11, and/or have identical cross-sectional areas. FIGS. 2 and 3 and FIGS. 5 and 6 show an exemplary embodiment in which the measuring chamber 5 and the reference chamber 7 have circular cross-sectional areas at least at the level of the first carrier region 11.

FIGS. 7 and 8 and FIGS. 11 and 12 show an exemplary embodiment in which the measuring chamber 5 and the reference chamber 7 have rectangular or square cross-sectional areas at least at the level of the first carrier region 11. FIGS. 9 and 10 show an exemplary embodiment in which the measuring chamber 5 and the reference chamber 7 have octagonal cross-sectional areas at least at the level of the first carrier region 11.

Regardless of their cross-sectional geometry, the measuring chamber 5 and/or the reference chamber 7 are each designed as a cuvette, e.g., as a glass cuvette or as a plastic cuvette. Cuvettes offer the advantage that they can be produced cost-effectively in an injection molding process.

Alternatively, the measuring chamber 5 and/or the reference chamber 7 is designed, for example, in such a way that it comprises a pipe segment R1, R2 of a pipe R produced in a pipe drawing process, such as a glass pipe drawn over a mandrel. Pipe drawing processes offer the advantage over injection molding processes that they allow for significantly higher precision of the pipe diameter and a more uniform and precise wall thickness of the pipe R. An advantageous embodiment, particularly with regard to the greatest possible correspondence between the dimensions of the pipe segment R1 of the measuring chamber 5 and the pipe segment R2 of the reference chamber 7 that are relevant for the measurements, consists in the pipe segment R1 of the measuring chamber 5 and the pipe segment R2 of the reference chamber 7 being portions of a single pipe R produced in a pipe drawing process. FIG. 15 shows method steps of a manufacturing process in which two pipe segments R1, R2 are produced by cutting to length from a single pipe R produced in a pipe drawing process, and then the measuring chamber 5 is produced from one of the pipe segments R1 and the reference chamber 7 is produced from the other pipe segment R2. In this case, the pipe segments R1, R2 are, for example, used in an orientation which causes the ends of the pipe segment R1 of the measuring chamber 5 and of the pipe segment R2 of the reference chamber 7 facing one another and/or adjacent to one another in the pipe R to both be arranged on the same side of the longitudinal axis L of the first carrier region 11 in the housing 1 of the measuring apparatus 100, 200, 300 in a direction parallel to the longitudinal axes of the pipe segments R1, R2. The alignment required for this is achieved by rotating one of the two pipe segments R1 by 180° around an axis perpendicular to its longitudinal axis.

Alternatively or additionally, for example, markings M1, M2 pointing in the same radial spatial direction are applied to the pipe segments R1, R2 on the outside of the pipe R. In this case, the measuring chamber 5 and the reference chamber 7 are inserted into the housing 1 in an orientation in which the marking M1 on the pipe segment R1 of the measuring chamber 5 and the marking M2 on the pipe segment R2 of the reference chamber 7 point in the same spatial direction running perpendicular to the longitudinal axes of both pipe segments R1, R2. FIG. 15 shows an exemplary embodiment in which the markings M1, M2 are arranged on the ends of the pipe segments R1, R2 that are adjacent to one another in the pipe R in such a way that they are adjacent to one another on the pipe R. Alternatively, the markings M1 and M2 can also be placed elsewhere.

Regardless of the positioning of the markings M1, M2, the alignment carried out using the markings M1, M2 offers the advantage that the greatest possible correspondence is achieved between the dimensions of the measuring chamber 5 relevant for the measurements and the dimensions of the reference chamber 7 relevant for the reference measurements.

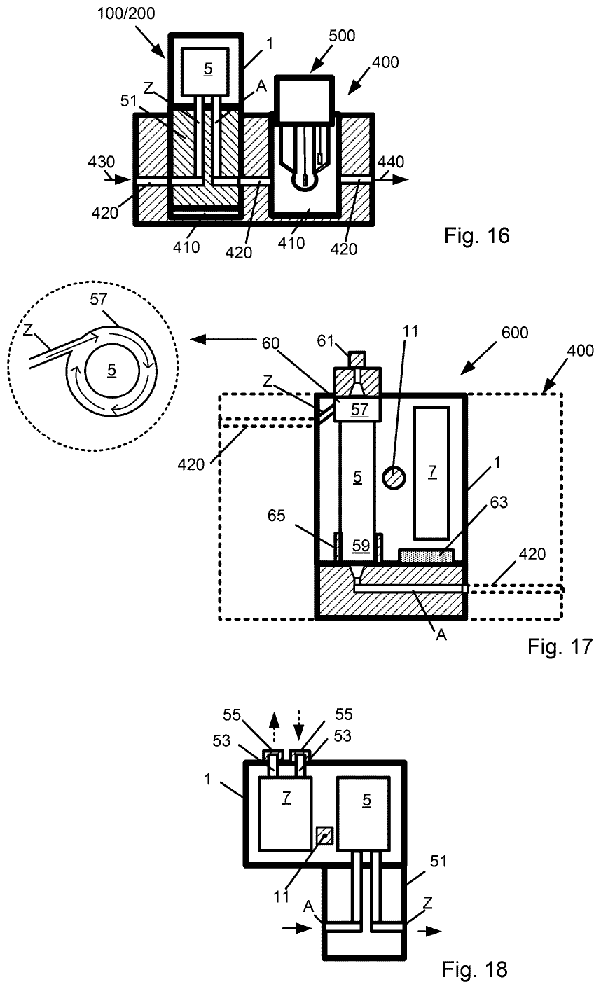

Irrespective of the relevant design, the flow cell 3 can, for example, be connected to a supply line arranged outside the housing 1 via an inlet Z opening into the measuring chamber 5 and to a discharge line arranged outside the housing 1 via an outlet A connected to the measuring chamber 5. FIGS. 1 and 4 show an exemplary embodiment in which the measuring apparatus 100, 200 is designed as a measuring module that can be inserted into a measuring module receptacle 410 of a measuring fitting 400. An exemplary embodiment of such a measuring fitting 400 is shown in FIG. 16. In the illustrated exemplary embodiments, the measuring apparatus 100, 200 comprises an extension 35 adjacent to the housing 1, through which the inlet Z connected to the measuring chamber 5 and the outlet A connected to the measuring chamber 5 run. As shown in FIG. 16, the measuring apparatus 100, 200 can be inserted into the measuring module receptacle 410 of the measuring fitting 400 in such a way that the inlet Z can be connected or is connected to a supply line 430 which can be connected to the measuring fitting 400 via channels 420 integrated in the measuring fitting 400 and the outlet A can be connected or is connected to a discharge line 440 which can be connected to the measuring fitting 400 via channels 420 integrated in the measuring fitting 400. The measuring fitting 400 can easily comprise at least one further measuring module receptacle 410 for receiving a further measuring module 500, such as a pH value measuring module shown as an example in FIG. 16, a flow measuring module or a measuring module for measuring another measured variable of the medium. In this case, the individual measuring module receptacles 410 are connected to one another, for example via channels 420 integrated in the measuring fitting 400, in such a way that the medium supplied to the measuring fitting 400 via the supply line 430 flows through the individual measuring module receptacles 410 in series or in parallel.

FIG. 17 shows a further exemplary embodiment of a measuring apparatus 600 designed analogously to the previously described measuring apparatuses 100, 200, 300, in which the inlet Z opens into a first end region 57 of the measuring chamber 5 and the outlet A is connected to a second end region 59 of the measuring chamber 5 opposite the first end region 57. This measuring apparatus 600 is also designed, for example, in such a way that it can be used in a measuring module receptacle of a measuring fitting 400 shown in dashed lines in FIG. 17. Here, too, the inlet Z can be connected via a channel 420 integrated in the measuring fitting 400 with a supply line that can be connected to the measuring fitting 400, and the outlet A can be connected via a channel 420 integrated in the measuring fitting 400 with a discharge line that can be connected to the measuring fitting 400.

Alternatively or additionally, the first end region 57 of the measuring chamber 5 is designed, for example, such that it forms or comprises a bubble trap 60. FIG. 17 shows an exemplary embodiment in which the inlet Z opens into an outer edge region of the first end region 57 of the measuring chamber 5. This results in the medium entering the first end region 57 via the inlet Z being set into a rotational movement, which causes the medium to be degassed. This rotational movement is illustrated in the partial figure circled in FIG. 17, which shows a plan view of the bubble trap 60 in which the flow path of the medium flowing in through the inlet Z is illustrated by arrows.

A further exemplary embodiment shown in FIG. 17 and which can also be used analogously in the other exemplary embodiments consists in that the measuring chamber 5 or its first end region 57 facing the inlet Z is equipped with a vent valve 61.

Alternatively or additionally, the reference chamber 7 can also be designed in different ways. FIGS. 1 and 4 show an exemplary embodiment in which the reference chamber 7 is designed as a closed chamber filled with the reference medium. This ensures reliable protection of the environment and operating personnel from direct contact with the reference medium. In this embodiment, the reference chamber 7 is designed, for example, as a replaceable component which can be exchanged, for example, for a identical replacement chamber if required.

FIG. 18 shows, as a further exemplary embodiment, a longitudinal section of a modification of the measuring apparatuses 100, 200, 300 shown in FIGS. 1 to 14, in which at least one channel 53 running through the housing 1 and designed as a filling and/or removal channel is connected to the reference chamber 7, the end of which channel arranged outside the housing 1 can be closed or is closed with a closure 55. This embodiment offers the advantage that the exchange of the reference medium can be carried out without opening the housing 1. This offers the advantage that no moisture can penetrate into the housing 1 and that the reference chamber 7 is located in exactly the same position within the housing 1 before and after the exchange of the reference medium and has exactly the same dimensions. The latter offers the advantage that the reference measurements can be carried out before and after each exchange under identical measurement conditions.

Irrespective of the relevant design of the reference chamber 7, any residual moisture trapped in the housing 1 can be additionally reduced by arranging a desiccant 63 made of a moisture-adsorbing material, such as zeolite or silica gel, in the housing 1. The desiccant 63 shown as an example in FIG. 17, which can also be used analogously in the other exemplary embodiments, is designed as a solid body, for example. Alternatively, a desiccant 63 in the form of granules or gel can also be used. In this case, the desiccant 63 is surrounded, for example, by a moisture-permeable wall, such as a wall made of silicone or silicone rubber.

A further optional embodiment consists in that at least one condensate trap 65 is arranged in the housing 1. For this purpose, an apparatus made of a material such as a metal that has high thermal conductivity that promotes the formation of condensate is suitable, for example. FIG. 17 shows an exemplary embodiment in which the condensate trap 65 is attached to a portion of the measuring chamber 5 which is located outside a measuring portion of the measuring chamber 5, in which measurements can be carried out on the medium located in the measuring portion using the optical sensor through a wall of the measuring portion. In this case, the condensate trap 65 is, for example, made of a material, such as a metal, which has a higher thermal conductivity than the material, such as glass or plastic, from which the wall of the measuring portion is made. FIG. 17 shows an exemplary embodiment in which the condensate trap 65 is designed, for example, as a sleeve surrounding the portion or as a coating applied to the outside of the portion. Alternatively, the condensate trap may also have a different shape and/or be arranged at a different location within the housing 1. If the temperature in the housing 1 falls below the dew point, the condensate trap 65 offers the advantage that any residual moisture contained in the housing 1 condenses primarily on the condensate trap 65. This protects the measuring chamber 5 and the reference chamber 7 from condensation, which could adversely affect the measurements and reference measurements that can be carried out using the optical sensor. This is particularly advantageous in locations where the temperature of the medium flowing through the measuring chamber 5 can fall below a dew point of the air enclosed in the housing 1.

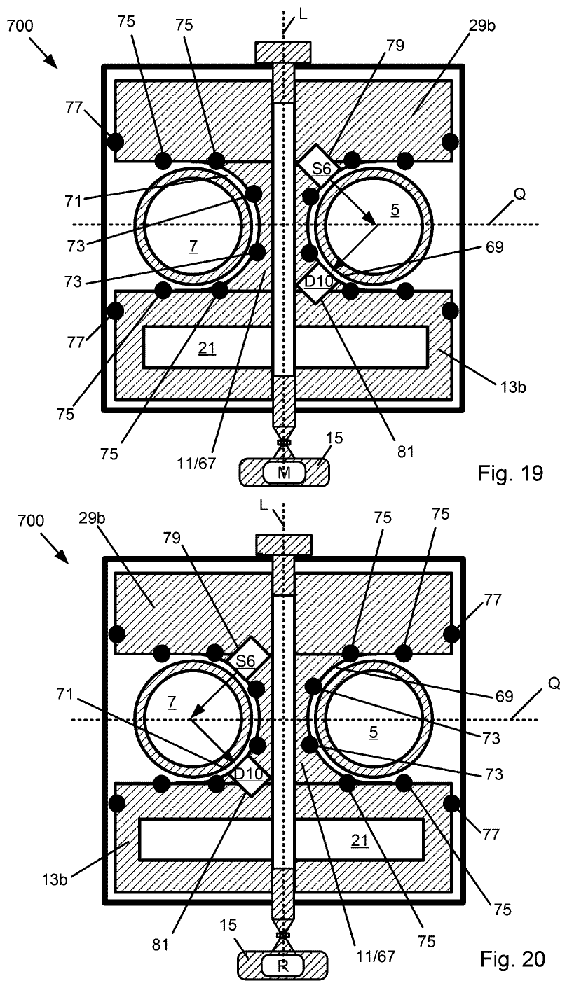

Alternatively or in addition to the previously described embodiments, the risk of condensate formation in the housing 1 can also be counteracted by reducing the free volume within the housing 1. This can be achieved, for example, by appropriately shaping the carrier 9. FIGS. 19 and 20 show an exemplary embodiment of a measuring apparatus 700, which is shown in FIG. 19 with the carrier 9 in the measuring position and in FIG. 20 with the carrier 9 in the reference position. The measuring apparatus 700 is shown in FIGS. 19 and 20 in a sectional plane running through the first carrier region 11, which is spanned by the longitudinal axis L of the first carrier region 11 and a transverse axis Q running perpendicular to the longitudinal axis L, wherein the transverse axis Q runs perpendicular to the longitudinal axes of the measuring chamber 5 and the reference chamber 7. In this exemplary embodiment, the second carrier region 13b arranged outside the cavity and the third carrier region 29b of the carrier 9 opposite the second carrier region 13b on the other side of the cavity each comprise a disc-shaped region, such as a disc-shaped region formed rotationally symmetrically to the longitudinal axis L of the first carrier region 11. The first carrier region 11 runs in a direction running parallel to its longitudinal axis L through the cavity arranged in the housing 1 between the measuring chamber 5 and the reference chamber 7. Accordingly, the first carrier region 11 comprises a region 67 arranged in the cavity. This region 67 is rotationally symmetrical to the longitudinal axis L of the first carrier region 11 and has a cross-sectional area which corresponds to a cross-sectional area of the cavity in the sectional plane shown. This embodiment offers the advantage that the region 67 arranged in the cavity almost completely fills the cavity in the sectional plane shown.

In this respect, an outer diameter of the region 67 arranged in the cavity is dimensioned at each position along the longitudinal axis of this region 67, for example, in such a way that between an outer circumferential surface of the measuring chamber 5 facing the longitudinal axis L of the first carrier region 11 and the region 67, as well as between an outer circumferential surface of the reference chamber 7 facing the longitudinal axis L of the first carrier region 11 and the region 67 in the sectional plane shown, there is a gap 69, 71 which has a gap width enabling the rotation of the carrier 9, such as a gap width of 0.05 mm to 1 mm. Analogously, the outer dimensions of the disc-shaped region of the second carrier region 13b and of the disc-shaped region of the third carrier region 29b are each dimensioned, for example, such that each of these regions has a cross-sectional area which corresponds to the cross-sectional area which one of the two partial regions of the housing interior adjacent to the cavity in the housing 1 has in the illustrated sectional plane.

In the exemplary embodiment shown in FIGS. 19 and 20, the measuring chamber 5 and the reference chamber 7 each have a circular cross-sectional area. Accordingly, the carrier 9 here has an hourglass-shaped cross-sectional geometry and the two gaps 69, 71 each have a circular ring-segment-shaped cross-sectional area in the illustrated sectional plane. The previously described dimensioning of the first carrier region 11, the second carrier region 13b and the third carrier region 29b can also be used analogously if the measuring chamber 5 and the reference chamber 7 have rectangular, square or octagonal cross-sectional areas.

A further embodiment consists in that the carrier 9 is equipped with at least one element 73, 75, 77 which at least partially delimits and/or reduces the free volume in the housing 1 directly or indirectly adjacent to the measuring chamber 5 and/or to the reference chamber 7. For this purpose, elements 73, 75, 77 designed as seals, such as O-rings or molded seals, which are available at low cost, are suitable. In this respect, the elements 73, 75, 77 are designed, for example, as individual parts which are each arranged concentrically to the longitudinal axis L of the first carrier region 11 and/or are inserted into a groove provided for this purpose in the carrier 9. Alternatively or additionally, each element 73, 75, 77 is designed, for example, as an element 73, 75, 77 projecting in a radial direction parallel to the longitudinal axis L or in an axial direction running perpendicular to the longitudinal axis L.

The elements 73, 75, 77 comprise, for example, at least one element 73 extending externally around the region 67 of the first carrier region 11 arranged in the cavity between the measuring chamber 5 and the reference chamber 7. FIGS. 19 and 20 show, as an exemplary embodiment, two elements 73 which are spaced apart from one another in a direction parallel to the longitudinal axis L of the first carrier region 11 and which run concentrically to the longitudinal axis L around the region 67 and project outwards in a radial direction running perpendicular to the longitudinal axis L.

Alternatively or additionally, the elements 73, 75, 77 comprise, for example, at least one element 75 arranged on an end face of the second carrier region 13b facing the measuring chamber 5 and the reference chamber 7 and/or at least one element 75 arranged on an end face of the third carrier region 29b facing the measuring chamber 5 and the reference chamber 7. Each of these elements 75 is arranged, for example, concentrically to the longitudinal axis L of the carrier region 11 such that it projects outwards in a direction parallel to the longitudinal axis L. FIGS. 19 and 20 show an exemplary embodiment in which the elements 75 arranged on the opposite end faces are arranged opposite one another in pairs.

A further embodiment shown in FIGS. 19 and 20 consists in that the elements 73, 75, 77 comprise, for example, at least one element 77 extending outside the disc-shaped region of the second carrier region 13b and/or at least one element 77 extending outside the disc-shaped region of the third carrier region 29b. Each of these elements 77 is arranged, for example, concentrically to the longitudinal axis L of the carrier region 11 such that it projects outwards in a direction running perpendicular to the longitudinal axis L.

Each of the previously described elements 73, 75, 77 provides additional protection against condensate formation of the wall region of the measuring chamber 5, through which the measurements on the medium are carried out, and the wall region of the reference chamber 7, through which the reference measurements on the reference medium are carried out.

A particularly advantageous embodiment in this respect consists in that the elements 73, 75, 77 comprise at least two elements 73, 75, each of which has a portion facing the measuring chamber 5 and a portion facing the reference chamber 7. This offers the advantage that gap regions of the gap 69 existing between the carrier 9 and the measuring chamber 5 and the gap 71 existing between the carrier 9 and the reference chamber 7, which gap regions run between two of these elements 73, 75, are limited in the axial and radial directions. A particularly advantageous embodiment, shown in FIGS. 19 and 20, consists in that at least one or each light source S6 and/or at least one or each detector D10 of the optical sensor is arranged in each case at a position in or on the carrier 9 located between two adjacent elements 73, 75.

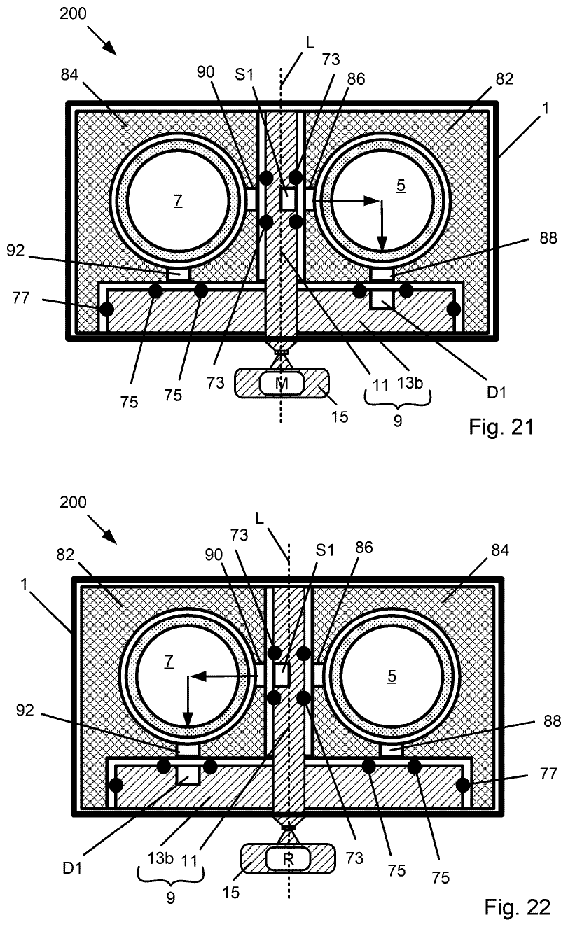

Regardless of the relevant design of the measuring apparatus 700, the cross-sectional geometry of the carrier 9 described above with reference to FIGS. 19 and 20 offers plenty of space for accommodating components of the measuring apparatus 700. In this respect, the measuring apparatus 700 shown in FIGS. 19 and 21 is also designed analogously to the previously described exemplary embodiments, for example, in such a way that its electronic system 21 is arranged in or on the carrier 9. In FIGS. 19 and 20, the electronic system 21 is arranged in an interior of the second carrier region 13b. Alternatively, it can also be arranged in the first carrier region 11, in the third carrier region 29b or at another location on or within the carrier 9 or in the rotary knob 15 connected to the carrier 9.

A further embodiment shown in FIGS. 19 and 20 and also evident in the figures for the previously described exemplary embodiments consists in that at least one or each light source Li, L6 and/or at least one or each detector Dj, D10 of the optical sensor is arranged in a recess 79, 81 of the carrier 9 which is open to the environment. The optical sensor is designed with regard to the number, position and orientation of the light source(s) Li and the or each detector Dj, for example, in one of the ways previously described with reference to FIGS. 1 to 12.

FIGS. 19 and 20 show another exemplary embodiment of the optical sensor comprising a light source S6 and a detector D10. The light source S6 is arranged such that, when the carrier 9 is in the measuring position, it emits light in a transmission direction running at an angle of 45° to the longitudinal axis L of the first carrier region 11 towards the center of the measuring chamber 5 and, when the carrier 9 is in the reference position, it emits light at an angle of 45° to the longitudinal axis L towards the center of the reference chamber 7. The detector D10 is arranged such that, when the carrier 9 is in the measuring position, it receives measuring radiation emerging from the measuring chamber 5 at an angle of 90° to the transmission direction resulting from an interaction of the light with the medium and, it receives measuring radiation emerging from the reference chamber 7 at an angle of 90° to the transmission direction resulting from an interaction of the light with the reference medium when the carrier 9 is in the reference position. Depending on the design of the light source S6 and the detector D10, interactions such as scattering or fluorescence excitation can be used. In this respect, the optical sensor is designed and/or usable as a turbidity sensor or as a fluorescence sensor. In conjunction with this embodiment of the optical sensor, the cross-sectional geometry of the carrier 9 of the measuring apparatus 700 shown in FIGS. 19 and 20 offers the advantage that in the transition regions of the carrier 9 from the region 67 of the first carrier region 11 arranged in the cavity to the second carrier region 13b and to the third carrier region 29b, there is plenty of space available for accommodating the diagonally aligned light source L6 and the diagonally aligned detector D10.

In the measuring apparatus 700 shown in FIGS. 19 and 20, the free volume enclosed in the housing 1 is reduced by the corresponding shape of the carrier 9. Alternatively or additionally, the free volume can also be reduced by at least one filler body arranged in the housing 1. The filler bodies are designed in such a way that they almost completely fill the free volume in the housing 1.

FIGS. 21 and 22 show an exemplary embodiment of the measuring apparatus 200 shown in FIG. 4, in which the measuring chamber 5 and/or the reference chamber 7 is surrounded on all sides by a filler body 82, 84. The filler body 82 surrounding the measuring chamber 5 has in each case a through-opening 86 for each light source S1 of the optical sensor, through which the corresponding light source S1 transmits light into the measuring chamber 5 when the carrier 9 is in the measuring position shown in FIG. 21. In addition, this filler body 82 has in each case a through-opening 88 for each detector D1 of the optical sensor, through which the corresponding detector D1 receives measuring radiation emerging from the measuring chamber 5 when the carrier 9 is in the measuring position. Analogously, the filler body 84 surrounding the reference chamber 7 has in each case a through-opening 90 for each light source S1 of the optical sensor, through which the corresponding light source S1 transmits light into the reference chamber 7 when the carrier 9 is in the reference position shown in FIG. 22. In addition, this filler body 84 has in each case a through-opening 92 for each detector D1 of the optical sensor, through which the corresponding detector D1 receives measuring radiation emerging from the measuring chamber 5 when the carrier 9 is in the reference position.

In this exemplary embodiment, the cavity arranged between the measuring chamber 5 and the reference chamber 7, into which the first carrier region 11 extends, is formed by recesses in the filler bodies 82, 84. In the exemplary embodiment shown in FIGS. 21 and 22, the second carrier region 13b is also arranged in recesses provided for this purpose in the filler bodies 82, 84. The recesses in the filler bodies 82, 84 are dimensioned such that they allow the rotation of the carrier 9.

Optionally, the carrier 9 of the measuring apparatus 200 shown in FIGS. 21 and 22 is also equipped, for example, with at least one of the elements 73, 75, 77 previously described in connection with FIGS. 19 and 20. A particularly advantageous embodiment here is that at least one or each light source S1 and/or at least one or each detector D1 of the optical sensor is arranged in each case at a position in or on the carrier 9 located between two adjacent elements 73, 75.

In FIGS. 21 and 22, the light source S1 arranged in or on the first carrier region 11 is arranged between two adjacent elements 73 which extend concentrically to the longitudinal axis L of the first carrier region 11 around the first carrier region 11 and project outwards in a direction running perpendicular to the longitudinal axis L of the first carrier region 11. These elements 73 offer the advantage that they reduce the gap volume of the gap which is indirectly adjacent to the measuring chamber 5 and the reference chamber 7 via the through-openings 86, 90 provided for the light source S1 in the filler bodies 82, 84 and which surrounds the first carrier region 11 on all sides on the outside. Analogously, the end face of the second carrier region 13b facing the measuring chamber 5 and the reference chamber 7 is equipped with two elements 75 which extend concentrically to the longitudinal axis L of the first carrier region 11 and project outwards relative to the end face in a direction parallel to the longitudinal axis L, between which the detector D1 of the optical sensor is arranged. These elements 75 offer the advantage that they reduce the gap volume of the gap between the end face of the second carrier region 13b and the filler bodies 82, 84, which gap is indirectly adjacent to the measuring chamber 5 and the reference chamber 7 via the through-openings 88, 92 provided for the detector D1 in the filler bodies 82, 84. The resulting protection of the measuring chamber 5 and the reference chamber 7 against condensate formation is additionally reinforced in FIGS. 21 and 22 by the optional outwardly projecting element 77 which extends concentrically to the longitudinal axis L on the outside around the second carrier region 13b.

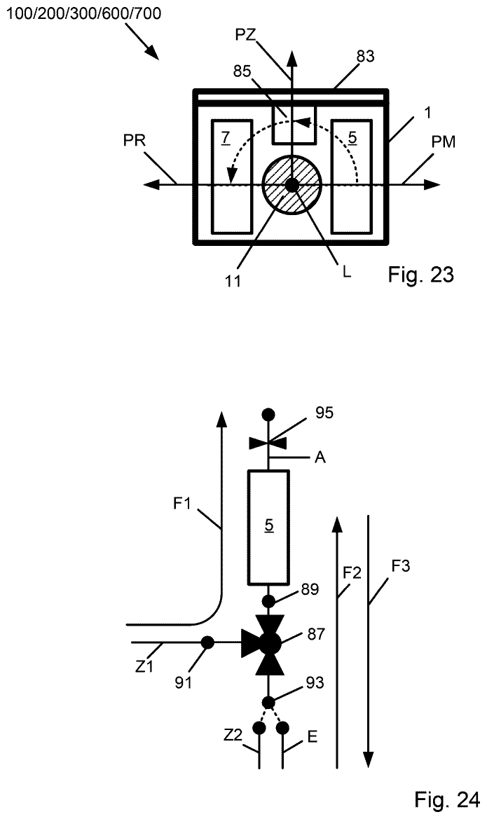

Analogous to the previously described exemplary embodiments, the carrier 9 of the measuring apparatus 700 shown in FIGS. 19 and 20, as well as of the measuring apparatus 200 shown in FIGS. 21 and 22, is also rotatably mounted in the housing 1 about the longitudinal axis L of the first carrier region 11, wherein the rotation of the carrier 9 from the measuring position into the reference position, as well as from the reference position into the measuring position, can also be effected in the manner described above. A further optional embodiment of the measuring apparatuses 100, 200, 300, 600, 700 described here is that the carrier 9 can be transferred into an intermediate position if necessary by a corresponding rotation of the carrier 9 about the longitudinal axis L. One embodiment of this is that each detector Dj and each light source Si of the optical sensor is aligned with a partial region of the interior of the housing 1 located between the measuring chamber 5 and the reference chamber 7 when the carrier 9 is in the intermediate position. FIG. 23 shows a schematic representation of an exemplary embodiment of the measuring apparatuses 100, 200, 300, 600, 700 described here, in which the carrier 9, starting from the measuring position indicated in FIG. 21 by an arrow PM, can be transferred by a rotation of 90° into the intermediate position indicated in FIG. 21 by an arrow PZ, and starting from the intermediate position can be transferred by a rotation of 90° into the reference position indicated in FIG. 23 by an arrow PR. The intermediate position offers additional protection of the optical sensor against damage, for example if the measuring chamber 5 and/or the reference chamber 7 need to be removed.

FIG. 23 shows an embodiment in which the housing 1 comprises a removable housing cover 83 which closes a housing opening through which each detector Dj and each light source Si is accessible when the carrier 9 is in the intermediate position. This offers the advantage, particularly in the case of the measuring apparatus 700 shown in FIGS. 19 and 20, that the detector D10 or each detector Dj and the light source S6 or each light source Si are accessible for any necessary cleaning after the housing cover 83 has been removed with the carrier 9 in the intermediate position, without the carrier 9 having to be removed from the housing 1.

A further embodiment, also shown in FIG. 23, consists in that a reference body 85 made of a reference material, such as Plexiglas or glass, is arranged in the housing 1 in such a way that reference measurements can be carried out on the reference body 85 using the optical sensor when the carrier 9 is in the intermediate position.

In this case, the measuring apparatus 100, 200, 300, 600, 700 is operated, for example, in such a way that at least one reference measurement is carried out on the reference body 85 using the optical sensor at least once, repeatedly or when required. In this respect, the measuring apparatus 100, 200, 300, 600, 700 is designed, for example, in such a way that, when the carrier 9 is in the intermediate position, it can be operated in an intermediate mode in which reference measurements can be carried out on the reference body 85 using the optical sensor. The reference measurements carried out in the intermediate mode are also carried out, for example, according to a sequence specified by the controller. Alternatively or additionally, the evaluation of the detector signals by means of the evaluation device 23 in the intermediate mode, for example, is carried out in a manner predetermined for the intermediate mode. Analogous to the above statements regarding the reference measurements carried out on the reference medium located in the reference chamber 7, a check of the measurement accuracy, a calibration and/or an adjustment of the optical sensor can also be carried out based on the reference measurements carried out on the reference body 85. Alternatively or additionally, the procedure is, for example, that based on at least one reference measurement carried out on the reference body 85, a check is carried out on at least one reference measurement carried out on the reference medium located in the reference chamber 7 and/or at least one property of the reference medium. This offers the advantage that any changes in the reference medium that may occur over time, as well as any existing or developing changes in the measuring properties of the measuring apparatus 100, 200, 300, 600, 700, can be detected and taken into account accordingly.

A further optional embodiment consists in that the measuring apparatus 100, 200, 300, 600, 700 comprises a connection apparatus which is operable in a first mode in which the measuring chamber 5 can be filled with the medium, and which is operable in a second mode in which the measuring chamber 5 can be filled with a reference fluid different from the medium. For this purpose, connection apparatuses of different designs connected to the measuring chamber 5 can be used. FIG. 24 shows a block diagram of an exemplary embodiment of a connection apparatus connected to the measuring chamber 5, which comprises a fitting 87, such as a multi-way valve, which comprises a measuring chamber connection 89 connected to the measuring chamber 5, a medium connection 91 which can be connected to a supply line Z1 carrying the medium, and a connection device 93. The connection device 93 is designed such that the measuring chamber 5 can be connected to a supply line Z2 carrying the reference fluid via the connection device 93 in order to fill the measuring chamber 5 with the reference fluid, and can be connected to a withdrawal line E via the connection device 93 in order to discharge reference fluid located in the measuring chamber 5.

In the illustrated exemplary embodiment, the fitting 87 can be operated in a first switching position such that the medium supplied via the supply line Z1 connected to the medium connection 91 flows into the measuring chamber 5 along a flow path F1 running via the fitting 87 to the measuring chamber 5 and flows out of the measuring chamber 5 via the discharge line A connected to the measuring chamber 5. In addition, the fitting 87 can be operated in a second switching position such that the reference fluid supplied via the supply line Z2 connected to the connection device 93 and carrying the reference fluid flows into the measuring chamber 5 along a flow path F2 running through the connection device 93 and the fitting 87 to the measuring chamber 5, and in a third switching position such that the reference fluid located in the measuring chamber 5 flows out of the measuring chamber 5 along a flow path F3 running through the fitting 87 and the connection device 93 to the extraction line E connected thereto. FIG. 24 shows an exemplary embodiment in which the fitting 87 is designed as a 3-way valve. In this case, the connection device 93 is a third connection of the 3-way valve which can be connected to the supply line Z2 carrying the reference fluid for filling the measuring chamber 5 with the reference fluid and to the extraction line E for removing the reference fluid. Alternatively, a 4-way valve can be used, which comprises a connection that can be connected to the supply line Z2 carrying the reference fluid and a connection that can be connected to the extraction line E.

Optionally, the connection apparatus can also be designed in a different way and/or comprise at least one further component. FIG. 24 shows an exemplary embodiment in which the connection apparatus comprises a shut-off apparatus 95 inserted into the outlet A for the medium, via which shut-off device the measuring chamber 5 can be ventilated when the measuring chamber 5 with the reference fluid is filled and/or when the reference fluid from the measuring chamber 5 is drained, and/or the outlet A can be shut off at least temporarily in such a way that the shut-off apparatus 95 prevents reference fluid from escaping from the measuring chamber 5 via the outlet A.

Regardless of the design of the connection apparatus, the ability to fill the measuring chamber 5 with the reference fluid offers the advantage that reference measurements can be carried out on the reference fluid located in the measuring chamber 5 using the optical sensor. In this respect, the measuring apparatus 100, 200, 300, 600, 700 equipped with the connection apparatus is operated, for example, in such a way that the measuring chamber 5 is filled with a reference fluid at least once, repeatedly or as required, and at least one reference measurement is carried out on the reference fluid located in the measuring chamber 5 using the optical sensor. Analogous to the above statements regarding the reference measurements carried out on the reference medium located in the reference chamber 7, the procedure here is also such that, for example, a check of the measurement accuracy, a calibration and/or an adjustment of the optical sensor are carried out based on the reference measurement(s) carried out on the reference fluid. Alternatively or additionally, the procedure is, for example, that based on the reference measurement(s) carried out on the reference fluid, a check is carried out on at least one reference measurement carried out on the reference medium located in the reference chamber 7 and/or at least one property of the reference medium. This offers the advantage that any changes in the reference medium that may occur over time, as well as any existing or developing differences in the measuring properties of the measuring apparatus 100, 200, 300, 600, 700 when the carrier 9 is in the measuring position and, when the carrier 9 is in the reference position, can be detected and taken into account accordingly.

1. A measuring apparatus for optically measuring at least one measured variable of a medium, the measuring apparatus comprising:
a closed housing;
a flow cell including a measuring chamber arranged in the housing configured to receive the medium;
a reference chamber arranged in the housing configured to receive a reference medium;
a carrier arranged in the housing including a first carrier region which extends into a cavity arranged between the measuring chamber and the reference chamber, and a second carrier region which extends outside the cavity at least in a direction extending perpendicular to a longitudinal axis of the first carrier region, wherein the carrier is rotatably mounted in the housing about the longitudinal axis of the first carrier region; and
an optical sensor for measuring the at least one measured variable, comprising at least one light source and at least one detector, which are arranged on the carrier such that measurements of the at least one measured variable can be performed on the medium located in the measuring chamber using the optical sensor when the carrier is in a measuring position that can be accessed by rotating the carrier, and reference measurements can be performed on the reference medium located in the reference chamber using the optical sensor when the carrier is in a reference position that can be accessed by rotating the carrier.

2. The measuring apparatus according to claim 1, wherein:
the first carrier region is rod-shaped; and
the second carrier region is embodied as a rod-shaped region extending on one side of the first carrier region in the direction extending perpendicular to the longitudinal axis of the first carrier region or includes a disc which also extends at least in the direction extending perpendicular to the first carrier region and/or is rotationally symmetrical to the longitudinal axis of first carrier region.

3. The measuring apparatus according to claim 1, wherein the carrier comprises a third carrier region,
on which a reflector is arranged or on which at least one light source or at least one detector of the optical sensor is arranged; and/or
which is arranged in the housing on a side of the cavity arranged between the measuring chamber and the reference chamber opposite the second carrier region outside the cavity; and/or
which extends in the direction extending perpendicular to the longitudinal axis of the first carrier region, and is designed as a rod-shaped region or comprises a disc.

4. The measuring apparatus according to claim 1, wherein:
each light source and each detector is arranged on a side of one of the carrier regions of the carrier facing the measuring chamber in the measuring position and the reference chamber in the reference position;
each light source is embodied to emit light of at least one wavelength or at least one wavelength in the ultraviolet, visual and/or infrared spectrum, and/or comprise one or more light-emitting diodes; and/or
each detector is positioned on the carrier such that, when the carrier is in the measuring position, it receives measuring radiation resulting from an interaction of the light transmitted by at least one light source with the medium and, when the carrier is in the reference position, it receives measuring radiation resulting from an interaction of the light transmitted by at least one light source with the reference medium, and/or is embodied such that it provides a detector signal corresponding to the received measuring radiation and/or comprises one or more photodiodes.

5. The measuring apparatus according to claim 1, wherein:
the optical sensor is embodied and/or usable as a turbidity sensor; and/or
at least one of the detectors is arranged on the carrier such that, when the carrier is in the measuring position, it receives measuring radiation resulting from scattering of the light transmitted into the medium by the at least one light source at a scattering angle predetermined by a position of a corresponding detector and, when the carrier is in the reference position, it receives measuring radiation resulting from scattering of light transmitted into the reference medium by the at least one light source at the scattering angle predetermined by the position of the corresponding detector.

6. The measuring apparatus according to claim 1, wherein:
the optical sensor is embodied and/or usable as an absorption sensor;
at least one light source and at least one detector of the optical sensor are arranged on the carrier such that an optical signal transmission path running from the at least one light source in a transmission direction of the at least one light source to the at least one detector includes a transmission path running through the measuring chamber when the carrier is in the measuring position and comprises a transmission path running through the reference chamber when the carrier is in the reference position; and/or
at least one first reflector and at least one second reflector are arranged in the housing, and at least one light source and at least one detector of the optical sensor are arranged on the carrier such that an optical signal transmission path running from the at least one light source to the at least one detector when the carrier is in the measuring position runs via at least one first reflector and comprises at least one transmission path running through the measuring chamber, and an optical signal transmission path running from the light source to the detector when the carrier is in the reference position runs via at least one second reflector and comprises at least one transmission path running through the reference chamber.

7. The measuring apparatus according to claim 3, wherein:
the carrier includes a third carrier region which is arranged in the housing on a side of the cavity arranged between the measuring chamber and the reference chamber opposite the second carrier region, outside the cavity,
a reflector is arranged on one of two opposing carrier regions formed by the second carrier region and the third carrier region, and
on an opposite carrier region, a light source and a detector are arranged such that an optical signal transmission path running from the at least one light source via the reflector to the at least one detector comprises a transmission path running through the measuring chamber when the carrier is in the measuring position, and comprises a transmission path running through the reference chamber when the carrier is in the reference position.

8. The measuring apparatus according to claim 1, wherein:
the optical sensor is embodied and/or usable as a fluorescence sensor, and/or
at least one light source and at least one detector of the optical sensor are embodied and arranged on the carrier such that a fluorescent component contained in the medium can be excited by the at least one light source when the carrier is in the measuring position and a fluorescent component contained in the reference medium can be excited when the carrier is in the reference position, and the detector receives light transmitted by the fluorescent component of the medium when the carrier is in the measuring position and light transmitted by the fluorescent component of the reference medium when the carrier is in the reference position and provides a detector signal corresponding to the received light.

9. The measuring apparatus according to claim 1, wherein:
the housing includes a housing cover detachably connected to a housing body of the housing; and/or
the carrier is fastened to a housing cover which is detachably connected to a housing body of the housing such that it can be removed from the housing body together with the housing cover.

10. The measuring apparatus according to claim 1, further comprising a detection apparatus for detecting a carrier position of the carrier, that detects when the carrier is in the measuring position and/or which detects when the carrier is in the reference position, and which provides an output signal corresponding to the carrier position, wherein the detection apparatus:
comprises two switches or two switches designed as pressure switches, proximity switches, or light barriers, which are positioned in the housing such that one of the switches can be triggered by the carrier in the measuring position and the other switch can be triggered by the carrier in the reference position;
is connected to a display for displaying the carrier position of the carrier determined by the detection apparatus; and/or
is connected to an electronic system of the measuring apparatus, via which the optical sensor is supplied with energy, including a controller for controlling measuring sequences to be performed using the optical sensor and/or for controlling the at least one light source and/or which makes the detector output signals available to an evaluation device which is embodied to determine and make available measurement results of the at least one measured variable of the medium based on the detector signals when the carrier is in the measuring position and/or measurement results of the measured variable of the reference medium when the carrier is in the reference position.

11. The measuring apparatus according to claim 1 embodied such that:
when the carrier is in the measuring position and/or depending on an output signal of a detection apparatus indicating the measuring position for detecting a carrier position of the carrier, the measuring device is operable in a measuring mode in which measurements can be performed on the medium using the optical sensor; and
when the carrier is in the reference position and/or depending on an output signal of the detection apparatus indicating the reference position, the measuring device is operable in a reference mode in which reference measurements can be performed on the reference medium using the optical sensor.

12. The measuring apparatus according to claim 1 embodied as a measuring module that is insertable into a measuring module receptacle of a measuring fitting, and/or:
comprises an extension adjacent to the housing, through which an inlet connected to the measuring chamber and an outlet connected to the measuring chamber run; and
is insertable into a measuring module receptacle of a measuring fitting such that the inlet is connectable to a supply line which is connectable to the measuring fitting via channels integrated in the measuring fitting and the outlet is connectable to a discharge line which is connectable to the measuring fitting via channels integrated in the measuring fitting.

13. The measuring apparatus according to claim 1, wherein:
the reference chamber is embodied as a closed and/or replaceable chamber filled with the reference medium, or
the reference chamber is embodied as a refillable chamber, wherein at least one channel extending through the housing and embodied as a filling and/or removal channel is connected to the reference chamber, the end of which channel arranged outside the housing can be or is closed with a closure.

14. The measuring apparatus according to claim 1 embodied such that:
the measuring chamber and the reference chamber, at least in their regions arranged at a level of the first carrier region, are mirror-symmetrical to the first carrier region and/or have identical cross-sectional areas;
the measuring chamber and the reference chamber have circular, rectangular, square or octagonal cross-sectional areas, at least in their regions arranged at the level of the first carrier region;
the carrier is connected to a rotary knob arranged outside the housing for rotating the carrier and/or to a drive arranged inside or outside the housing or to an electric motor for rotating the carrier;
the measuring apparatus comprises a first stop against which the carrier strikes when accessing the measuring position, and/or a second stop against which the carrier strikes when accessing the reference position;
the measuring apparatus comprises a fixing apparatus, a fixing apparatus with magnets and magnets of opposite polarity, a locking apparatus with mutually complementary locking elements or a parking brake, by which the carrier can be fixed in the measuring position and/or in the reference position;
the carrier, on the carrier or in a rotary knob which is connected to the carrier, or which can be connected or coupled to an electronic system via which the optical sensor is supplied with energy, comprising a controller for controlling measuring sequences to be performed using the optical sensor and/or for controlling the at least one light source, and/or provides the detector signals of each detector to an evaluation device connected or connectable to the electronic system, wherein the evaluation device is designed to determine and provide measurement results of the at least one measured variable of the medium based on the detector signals when the carrier is in the measuring position and/or measurement results of the at least one measured variable of the reference medium when the carrier is in the reference position; and/or
at least one light source and/or at least one detector of the optical sensor is arranged in a recess of the carrier which is open to the environment.

15. The measuring apparatus according to claim 1, wherein:
the measuring chamber and the reference chamber each comprise a pipe segment of a pipe produced in a pipe drawing process; or
a pipe segment of the measuring chamber and a pipe segment of the reference chamber are portions of a single pipe produced in a pipe drawing process, wherein:
the pipe segments have ends facing each other in the pipe and/or adjoining each other in the pipe;
in the pipe, mutually facing ends of the two pipe segments in the housing are both arranged on a same side of the longitudinal axis of the first carrier region in a direction parallel to the longitudinal axes of the pipe segments; and/or
markings pointing in a same radial spatial direction are applied to the pipe segments on an outside of the pipe, and the measuring chamber and the reference chamber are inserted into the housing in an orientation in which the marking on the pipe segment of the measuring chamber and the marking on the pipe segment of the reference chamber point in the same spatial direction running perpendicular to the longitudinal axes of the pipe segments.

16. The measuring apparatus according to claim 1, wherein:
the measuring chamber is equipped with a vent valve; and/or
an inlet which can be connected to a supply line and opens into a first end region of the measuring chamber, wherein the first end region forms or comprises a bubble trap, and/or the inlet opens into an outer edge region of the first end region.

17. The measuring apparatus according to claim 1, wherein:
a desiccant comprising a moisture-adsorbing material, a zeolite or silica gel is arranged in the housing; and/or
at least one condensate trap is arranged in the housing and/or a condensate trap arranged in the housing is attached to a portion of the measuring chamber which lies outside a measuring portion of the measuring chamber, in which measurements are performable on the medium using the optical sensor through a wall of the measuring portion, wherein the at least one condensate trap:
is designed as a sleeve or coating surrounding an outside of the portion of the measuring chamber, and/or
consists of a metal or a material that has a higher thermal conductivity than the wall of the measuring portion of the measuring chamber through which measurements can be performed on the medium using the optical sensor.

18. The measuring apparatus according to claim 1, wherein:
the second carrier region arranged outside the cavity arranged between the measuring chamber and the reference chamber and a third carrier region of the carrier opposite the second carrier region on the other side of the cavity each include a disc-shaped and/or rotationally symmetrical region to the longitudinal axis of the first carrier region, and
a region of the first carrier region arranged in the cavity is rotationally symmetrical to the longitudinal axis of the first carrier region and has a cross-sectional area in a sectional plane spanned by the longitudinal axis of the first carrier region and a transverse axis extending perpendicular to the longitudinal axis of the first carrier region and perpendicular to the longitudinal axes of the measuring chamber and the reference chamber, wherein the cross-sectional area corresponds to a cross-sectional area of the cavity, which the cavity has in this sectional plane.

19. The measuring apparatus according to claim 18, wherein:
the region of the first carrier region arranged in the cavity has an outer diameter at each position along its longitudinal axis, which is dimensioned such that between an outer circumferential surface of the measuring chamber facing the longitudinal axis of the first carrier region and the region, as well as between an outer circumferential surface of the reference chamber facing the longitudinal axis of the first carrier region and the region, in a sectional plane spanned by the longitudinal axis of the first carrier region and a transverse axis running perpendicular to the longitudinal axis of the first carrier region and perpendicular to the longitudinal axes of the measuring chamber and the reference chamber, there is a gap which has a gap width enabling the rotation of the carrier and/or a gap width of 0.05 mm to 1 mm, and/or
the outer dimensions of the disc-shaped region of the second carrier region and of the disc-shaped region of the third carrier region are each dimensioned such that each of these regions has a cross-sectional area which corresponds to a cross-sectional area which one of the two partial regions of the housing interior adjacent to the cavity in the housing comprises in the sectional plane spanned by the longitudinal axis of the first carrier region and the transverse axis running perpendicular to the longitudinal axis of the first carrier region and perpendicular to the longitudinal axes of the measuring chamber and the reference chamber.

20. The measuring apparatus according to claim 1, wherein:
at least one filler body is arranged in the housing, and/or
the measuring chamber is surrounded externally on all sides by a filler body which has in each case a through-opening for each light source, through which a corresponding light source transmits light into the measuring chamber when the carrier is in the measuring position, and has in each case a through-opening for each detector through which a corresponding detector receives measuring radiation emerging from the measuring chamber when the carrier is in the measuring position, and/or
the reference chamber is surrounded externally on all sides by a filler body which has a through-opening for each light source, through which a corresponding light source transmits light into the reference chamber when the carrier is in the reference position, and has a through-opening for each detector, through which a corresponding detector receives measuring radiation emerging from the measuring chamber when the carrier is in the reference position.

21. The measuring apparatus according to claim 1, wherein the carrier is equipped with at least one element which at least partially delimits and/or reduces the free volume in the housing directly or indirectly adjacent to the measuring chamber and/or to the reference chamber, wherein:
each element is annular, is embodied as a seal, as an O-ring or as a shaped seal, is inserted into a groove provided for this purpose in the carrier, is embodied as an element projecting in a radial direction running parallel to the longitudinal axis or in an axial direction running perpendicular to the longitudinal axis, and/or is arranged concentrically to the longitudinal axis of the first carrier region,
the elements include:
at least one element extending externally around the first carrier region,
at least one element arranged on one end face of the second carrier region or the third carrier region facing the measuring chamber and the reference chamber,
at least two elements arranged opposite one another on the mutually facing end faces of the second carrier region and the third carrier region, and/or at least one element extending outside the disc-shaped region of the second carrier region and/or at least one element extending outside the disc-shaped region of the third carrier region,
at least two elements each having a portion facing the measuring chamber and a portion facing the reference chamber, and/or
at least one or each light source and/or at least one or each detector of the optical sensor is arranged at a position in or on the carrier located between two mutually adjacent elements.

22. The measuring apparatus according to claim 1, wherein the optical sensor is embodied and/or usable as a turbidity sensor or as a fluorescence sensor, and/or the optical sensor further comprises:
a light source which is designed to transmit light into the measuring chamber in a transmission direction running at an angle of 45° to the longitudinal axis of the first carrier region when the carrier is in the measuring position and to transmit light into the reference chamber at an angle of 45° to the longitudinal axis when the carrier is in the reference position; and
a detector embodied to receive measuring radiation emerging from the measuring chamber at an angle of 90° to the transmission direction, resulting from an interaction of the light with the medium when the carrier is in the measuring position, and to receive measuring radiation emerging from the reference chamber at an angle of 90° to the transmission direction resulting from an interaction of the light with the reference medium when the carrier is in the reference position.

23. The measuring apparatus according to claim 1, wherein:
the carrier can be transferred into an intermediate position by rotating the carrier around the longitudinal axis of the first carrier region, wherein:
each detector and each light source of the optical sensor is aligned with a partial region of an interior of the housing located between the measuring chamber and the reference chamber when the carrier is in the intermediate position,
the housing has a removable housing cover which closes a housing opening through which each detector and each light source of the optical sensor is accessible when the carrier is in the intermediate position, and/or
a reference body made of Plexiglas, glass or a reference material is arranged in the housing such that reference measurements are performable on the reference body using the optical sensor when the carrier is in the intermediate position.

24. The measuring apparatus according to claim 1, further comprising a connection apparatus which is operable in a first mode in which the measuring chamber is fillable with the medium via the connection apparatus, and which is operable in a second mode in which the measuring chamber is fillable with a reference fluid different from the medium via the connection apparatus, wherein:
the connection apparatus is connected to the measuring chamber; and/or
the connection apparatus comprises a fitting or a fitting comprising a multi-way valve, wherein the fitting:
comprises a measuring chamber connection connected to the measuring chamber,
comprises a medium connection which can be connected to a supply line carrying the medium and via which the measuring chamber is fillable with the medium, and
comprises a connection device via which the measuring chamber is connectable to a supply line carrying the reference fluid for filling the measuring chamber with the reference fluid and via which the measuring chamber can be connected to a withdrawal line for discharging reference fluid located in the measuring chamber; and/or
the connection apparatus comprises a shut-off apparatus inserted into an outlet for the medium connected to the measuring chamber, wherein the measuring chamber is ventilatable via the shut-off apparatus when the measuring chamber with the reference fluid is filled and/or when the reference fluid from the measuring chamber is drained, and/or via which the outlet can be shut off at least temporarily such that the shut-off apparatus prevents reference fluid from escaping from the measuring chamber via the outlet.

25. A method for operating a measuring apparatus according to claim 1, comprising the steps of:
performing measurements of the at least one measured variable of the medium using the optical sensor when the carrier is in the measuring position,
performing at least one reference measurement on the reference medium in the reference chamber using the optical sensor at least once, repeatedly or when required with the carrier in the reference position, and
checking the measurement accuracy based on the at least one reference measurement, a calibration and/or an adjustment of the optical sensor.

26. The method according to claim 25, further comprising the steps of:
transferring the carrier at least once, repeatedly or as required into an intermediate position in which reference measurements can be performed using the optical sensor on a reference body arranged in the housing, and based on at least one reference measurement performed on the reference body, a check of the measurement accuracy, a calibration and/or an adjustment of the optical sensor is performed, and/or a check of at least one reference measurement is performed on the reference medium located in the reference chamber and/or at least one property of the reference medium is determined, and/or
filling the measuring chamber with a reference fluid at least once, repeatedly or as required, wherein at least one reference measurement is performed on the reference fluid in the measuring chamber using the optical sensor, and based on the at least one reference measurement performed on the reference fluid, a check of the measurement accuracy, a calibration and/or an adjustment of the optical sensor is performed, and/or a check of at least one reference measurement is performed on the reference medium in the reference chamber and/or at least one property of the reference medium is determined.
